(19) United States
(12) Patent Application Publication
(10) Pub. No.: US 2026/0082126 A1
(43) Pub. Date: Mar. 19, 2026

(54) FOCUSING CONTROL DEVICE, OPERATION METHOD OF FOCUSING CONTROL DEVICE, OPERATION PROGRAM OF FOCUSING CONTROL DEVICE, AND IMAGING APPARATUS

(71) Applicant: FUJIFILM Corporation, Tokyo (JP)

(72) Inventor: Ryosuke NAGAMI, Saitama (JP)

(73) Assignee: FUJIFILM Corporation, Tokyo (JP)

(21) Appl. No.: 19/324,165

(22) Filed: Sep. 10, 2025

(30) Foreign Application Priority Data
Sep. 13, 2024 (JP) 2024-159576

(51) Int. Cl. H04N 23/67; H04N 23/667; H04N 25/704

(52) U.S. Cl. CPC H04N 23/672; H04N 23/667; H04N 25/704

(57) ABSTRACT

A focusing calculation unit acquires a focusing evaluation value by calculating a defocus amount in accordance with a first calculation signal after addition and a second calculation signal after addition, which are added values of calculation signals of calculation data which are pixel values of a plurality of phase-difference detection pixels. The focus lens driving controller performs focusing control using a suitable defocus amount that is a defocus amount satisfying an employment condition.

### CROSS-REFERENCE TO RELATED APPLICATIONS

The present application claims priority under 35 U.S.C. § 119 to Japanese Patent Application No. 2024-159576, filed on Sep. 13, 2024. The above application is hereby expressly incorporated by reference, in its entirety, into the present application.

### BACKGROUND

### 1. Technical Field

The technology of the present disclosure relates to a focusing control device, an operation method of a focusing control device, an operation program of a focusing control device, and an imaging apparatus.

### 2. Description of the Related Art

JP7023701B discloses an imaging apparatus including an imaging element, a calculation unit, a detection unit, and a focus adjustment unit. The imaging element outputs a pair of image signals based on a pair of light beams that have passed through different exit pupil regions of an imaging optical system including a focus lens. The calculation unit calculates a plurality of focus adjustment evaluation values with different setting conditions based on a pair of image signals in a focus adjustment region in the image captured by the imaging element. The detection unit detects a plurality of saturation levels for each of a plurality of focus adjustment evaluation values. The focus adjustment unit drives the focus lens using a focus adjustment evaluation value for focus adjustment selected based on a plurality of saturation levels among the plurality of focus adjustment evaluation values. The setting condition is at least one of a visual field range in which the focus adjustment evaluation value is calculated, a filter applied to the pair of image signals, or the number of pixels added by the horizontal pixel addition performed on the pair of image signals. The detection unit changes a parameter used in detecting a plurality of saturation levels based on the setting condition.

### SUMMARY

One embodiment according to the technology of the present disclosure provides a focusing control device, an operation method of a focusing control device, an operation program of a focusing control device, and an imaging apparatus capable of suppressing a decrease in detection accuracy of a distance to a subject based on an output from a phase-difference detection pixel.

A focusing control device of the present disclosure comprises a processor, in which the processor is configured to acquire a focusing evaluation value corresponding to an added value of pixel values of a plurality of phase-difference detection pixels, and perform focusing control using the focusing evaluation value satisfying a predetermined condition.

It is preferable that the processor is configured to detect a distance to a subject based on the focusing evaluation value satisfying the condition, and performs the focusing control corresponding to the distance.

It is preferable that the condition is that the focusing evaluation value related to a difference between a current position of a focus lens and a focusing position of the focus lens is within a first threshold value range.

It is preferable that the processor is configured to set a speed of the focus lens to a speed at which the predetermined number of the focusing evaluation values can be ensured.

It is preferable that the processor is configured to switch between a pixel addition mode in which the pixel value is added and a non-pixel addition mode in which the pixel value is not added.

It is preferable that the focusing evaluation value satisfying the condition is the focusing evaluation value acquired after a first threshold value number from when the non-pixel addition mode is switched to the pixel addition mode.

It is preferable that the processor is configured not to set the focusing evaluation value, which is acquired until a setting time elapses after switching from the non-pixel addition mode to the pixel addition mode, as the focusing evaluation value satisfying the condition.

It is preferable that the processor is configured to obtain a contrast value in a set region on an imaging surface of an imaging element in which the phase-difference detection pixels are arranged, and the focusing evaluation value satisfying the condition is the focusing evaluation value calculated in a case where the contrast value is within a second threshold value range.

It is preferable that the processor is configured to obtain an intensity of a frequency component in a set region on an imaging surface of an imaging element in which the phase-difference detection pixels are arranged, and the focusing evaluation value satisfying the condition is the focusing evaluation value calculated in a case where the intensity at a reference frequency is within a third threshold value range.

It is preferable that the processor is configured not to perform the focusing control using the focusing evaluation value in a case where the focusing evaluation value satisfying the condition is not present.

It is preferable that the processor is configured to add the pixel values of a plurality of the phase-difference detection pixels that are connected in a phase-difference detection direction.

An operation method of a focusing control device of the present disclosure includes acquiring a focusing evaluation value corresponding to an added value of pixel values of a plurality of phase-difference detection pixels, and performing focusing control using the focusing evaluation value satisfying a predetermined condition.

An operation program of a focusing control device of the present disclosure causes a computer to execute a process comprising acquiring a focusing evaluation value corresponding to an added value of pixel values of a plurality of phase-difference detection pixels, and performing focusing control using the focusing evaluation value satisfying a predetermined condition.

An imaging apparatus according to the present disclosure comprises the focusing control device described above.

### BRIEF DESCRIPTION OF THE DRAWINGS

Exemplary embodiments according to the technique of the present disclosure will be described in detail based on the following figures, wherein:

FIG. 1 is a diagram showing a configuration of an imaging apparatus;

FIG. 2 is a diagram showing an arrangement of pixels of an imaging element;

FIG. 3 is a diagram showing a configuration of a normal pixel;

FIG. 4 is a diagram showing a configuration of a first phase-difference detection pixel;

FIG. 5 is a diagram showing a configuration of a second phase-difference detection pixel;

FIG. 6 is a graph showing a phase difference between a first calculation signal and a second calculation signal;

FIG. 7 is a diagram showing a focus adjustment region;

FIGS. 8A and 8B are diagrams showing calculation data, in which FIG. 8A shows first calculation data and FIG. 8B shows second calculation data;

FIG. 9 is a block diagram showing a detailed configuration of a controller;

FIG. 10 is a block diagram showing processing units of a CPU;

FIG. 11 is a block diagram showing a detailed configuration of a focusing calculation unit;

FIGS. 12A and 12B are diagrams showing processing of a pixel addition unit, in which FIG. 12A shows processing on first calculation data and FIG. 12B shows processing on second calculation data;

FIG. 13 is a diagram showing processing of a correlation calculation unit;

FIG. 14 is a diagram showing a scene in which a subject distance is changed greatly, in which (A) of FIG. 14 shows a case where a mountain in a distant view is used as a subject and (B) of FIG. 14 shows a case where the subject is switched from the mountain in the distant view to a person in a near view;

FIG. 15 is a diagram showing a correlation curve in a case where a subject distance is largely changed and detection of a phase difference and calculation of a defocus amount are not possible;

FIG. 16 is a diagram for explaining a reason for performing pixel addition in a case where a subject distance is largely changed;

FIG. 17 is a diagram showing processing of a mode switching setting unit and a mode switching unit;

FIG. 18 is a diagram showing an employment condition;

FIG. 19 is a diagram showing an employability determination result in a case where the defocus amount satisfies the employment condition in the pixel addition mode;

FIG. 20 is a diagram showing an employability determination result in a case where the defocus amount does not satisfy the employment condition in the pixel addition mode;

FIGS. 21A and 21B are diagrams showing processing of a distance detection unit, in which FIG. 21A shows a case where there is the required number of suitable defocus amounts and FIG. 21B shows a case where there is no required number of suitable defocus amounts;

FIG. 22 is a diagram showing transitions of a current position and an estimated focusing position of a focus lens in a case where a distant view is switched to a near view;

FIG. 23 is a diagram showing transitions of a current position and an estimated focusing position of a focus lens in a case where a distant view is switched to a near view;

FIG. 24 is a diagram showing transitions of a current position and an estimated focus position of a focus lens in a case where a distant view is switched to a near view and the subject is moving;

FIG. 25 is a flowchart showing the processing procedure of the controller;

FIG. 26 is a diagram showing a case where the number of suitable defocus amounts is less than the required number;

FIG. 27 is a diagram showing a second embodiment in which a speed of the focus lens is set to be slow in a case where the number of suitable defocus amounts is less than the required number;

FIG. 28 is a diagram showing another example of the employment condition;

FIG. 29 is a diagram showing transitions of a current position and an estimated focusing position of a focus lens in a case where a distant view is switched to a near view;

FIG. 30 is a diagram showing a fourth embodiment in which a suitable defocus amount is determined based on a contrast value;

FIG. 31 is a diagram showing a fifth embodiment in which a suitable defocus amount is determined based on an intensity of a frequency component;

FIG. 32 is a graph showing processing of an employability determination unit of a fifth embodiment; and

FIG. 33 is a diagram showing another example of a second switching condition.

### DETAILED DESCRIPTION

### First Embodiment

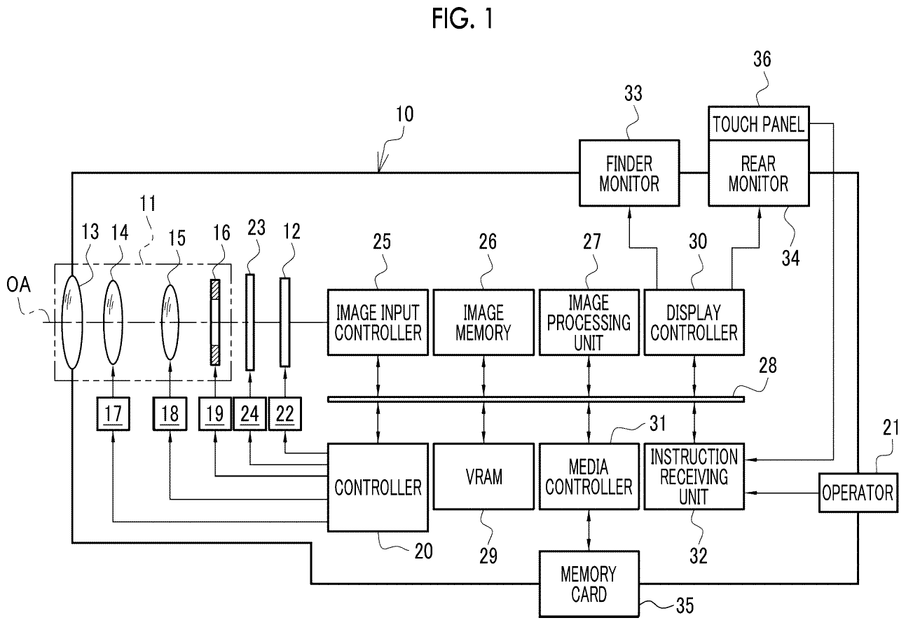

As shown in FIG. 1 as an example, an imaging apparatus 10 is, for example, a mirrorless single-lens digital camera, and comprises an imaging optical system 11 and an imaging element 12. The imaging optical system 11 includes a plurality of types of lenses for forming an image of subject light on the imaging element 12. Specifically, the imaging optical system 11 includes an objective lens 13, a focus lens 14, and a zoom lens 15. Each of these lenses 13 to 15 is disposed in this order from an object side (subject side) toward an image-forming side (imaging element 12 side). Although shown in FIG. 1 in a simplified manner, each of the lenses 13 to 15 is actually a lens group in which a plurality of lenses are combined. The imaging optical system 11 also includes a stop 16. The stop 16 is disposed closest to the image-forming side in the imaging optical system 11. It should be noted that the imaging apparatus 10 may be a type in which a lens barrel with a built-in imaging optical system 11 and the like is integrated with a body with the built-in imaging element 12 and the like, or may be a so-called lens interchangeable type in which the lens barrel and the body are separate bodies.

The focus lens 14 is provided with a focus lens drive mechanism 17, the zoom lens 15 is provided with a zoom lens drive mechanism 18, and the stop 16 is provided with a stop drive mechanism 19. The focus lens drive mechanism 17 includes a focusing cam ring that holds the focus lens 14 and is formed with a cam groove on the outer periphery, a focusing motor that rotates the focusing cam ring about an optical axis OA to move the focusing cam ring along the optical axis OA, a driver of the focusing motor, and the like. Similarly, the zoom lens drive mechanism 18 includes a zooming cam ring that holds the zoom lens 15 and is formed with a cam groove on the outer periphery, a zooming motor that rotates the zooming cam ring about an optical axis OA to move the zooming cam ring along the optical axis OA, a driver of the zooming motor, and the like. The stop drive mechanism 19 includes a stop motor that opens and closes a plurality of stop leaf blades of the stop 16, a driver of the stop motor, and the like.

The focusing motor, the zooming motor, and the stop motor are, for example, stepping motors. In this case, a position of the focus lens 14 and a position of the zoom lens 15 on the optical axis OA and an aperture of the stop 16 can be derived from drive amounts of the focusing motor, the zooming motor, and the stop motor. It should be noted that a position sensor may be provided to detect the positions of the focus lens 14 and the zoom lens 15, instead of the drive amounts of the focusing motor and the zooming motor.

The electric components such as the motor or the driver of each of the drive mechanisms 17 to 19 are connected to a controller 20. The electric components of each of the drive mechanisms 17 to 19 are driven under the control of the controller 20. More specifically, the controller 20 issues a drive signal in response to an instruction from a user, which is input via an operation unit 21, to drive the electric components of each of the drive mechanisms 17 to 19. For example, in a case where an instruction to change an angle of view to a telephoto side is input via an angle-of-view change switch of the operation unit 21, the controller 20 issues the drive signal to move the zoom lens 15 to the telephoto side to the driver of the zooming motor of the zoom lens drive mechanism 18.

The focusing motor, the zooming motor, and the stop motor output the drive amounts to the controller 20. The controller 20 derives the position of the focus lens 14 and the position of the zoom lens 15 on the optical axis OA and the aperture of the stop 16 based on the drive amounts.

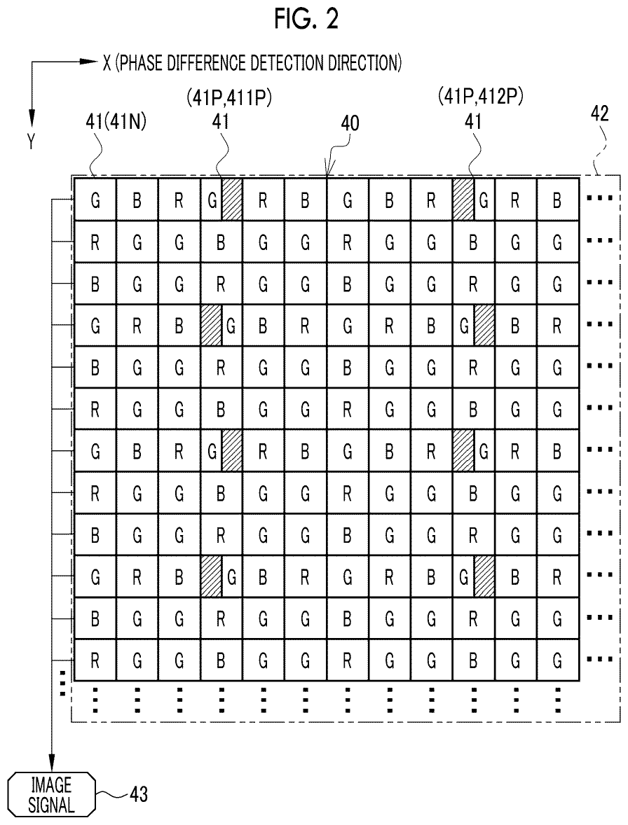

The imaging element 12 is, for example, a complementary metal-oxide-semiconductor (CMOS) image sensor, and has an imaging surface 42 (see FIG. 2) that images the subject light. The imaging element 12 is disposed such that a center of the imaging surface 42 matches the optical axis OA, and the imaging surface 42 is orthogonal to the optical axis OA. It should be noted that the terms “match” and “orthogonal” used herein mean not only perfect match and orthogonality but also match and orthogonality in a sense including an error generally allowed in the technical field to which the technology of the present disclosure belongs.

An imaging element driver 22 is connected to the imaging element 12. The imaging element driver 22 is connected to the controller 20. The imaging element driver 22 performs, under the control of the controller 20, supply of a vertical scanning signal and a horizontal scanning signal to the imaging element 12 or the like to control an imaging timing of the subject light by the imaging element 12.

A shutter 23 is provided between the imaging optical system 11 and the imaging element 12. The shutter 23 is, for example, a focal-plane shutter including a front curtain and a rear curtain. A shutter drive mechanism 24 is connected to the shutter 23. The shutter drive mechanism 24 includes an electromagnet that holds the front curtain and the rear curtain and releases the holding thereof to cause the front curtain and the rear curtain to travel, a driver of the electromagnet, and the like. The shutter drive mechanism 24 is driven, under the control of the controller 20, to open and close the shutter 23.

The controller 20 is connected to the respective units, such as an image input controller 25, an image memory 26, and an image processing unit 27, through a busline 28. In addition, the busline 28 is connected to a video random-access memory (VRAM) 29, a display controller 30, a media controller 31, an instruction receiving unit 32, and the like. It should be noted that, although not shown, the busline 28 is also connected to a strobe drive controller that controls the drive of a strobe device, an external communication interface (I/F) for communicating with an external device via a connection terminal such as a universal serial bus (USB) terminal, or a wireless communication I/F.

Image data obtained by imaging the subject light is input to the image input controller 25 from the imaging element 12. The image input controller 25 outputs the image data to the image memory 26. The image memory 26 is, for example, a synchronous dynamic random-access memory (SDRAM), and temporarily stores the image data.

The image processing unit 27 reads out unprocessed image data from the image memory 26. The image processing unit 27 performs various types of image processing on the image data. Examples of the various types of image processing include offset correction processing, sensitivity correction processing, pixel interpolation processing, white balance correction processing, gamma correction processing, demosaicing processing, generation processing of a brightness signal and a color difference signal, contour enhancement processing, and color correction processing. The image processing unit 27 writes the image data, which has been subjected to the various types of image processing, back to the image memory 26.

The image data, which has been subjected to the various types of image processing and is displayed as a live view image (also referred to as live preview image), is input into the VRAM 29 from the image memory 26. The VRAM 29 has a region for storing the image data for two consecutive frames. The image data stored in the VRAM 29 is sequentially rewritten with new image data. The VRAM 29 sequentially outputs newer image data of the image data for two consecutive frames to the display controller 30.

The display controller 30 has a so-called video encoder function of converting the image data from the VRAM 29 into video data and outputting the converted video data to any one of a finder monitor 33 or a rear monitor 34. Accordingly, the user can visually recognize the live view image through any one of the finder monitor 33 or the rear monitor 34. A display frame rate of the live view image is, for example, 60 frames per second (fps).

It should be noted that whether to output the video data to the finder monitor 33 or the rear monitor 34 is decided on as follows, for example. That is, a pupil detection sensor is provided in a finder. In a case where the pupil detection sensor detects that the user looks into the finder, the video data is output to the finder monitor 33. On the contrary, in a case where the pupil detection sensor detects that the user does not look into the finder, the video data is output to the rear monitor 34.

In a case where an instruction to start capturing of a still image or a video is issued by a full-press operation on a release button of the operation unit 21, the image processing unit 27 performs compression processing on the image data of the image memory 26. In a case of the still image, the image processing unit 27 performs, for example, compression processing of a joint photographic experts group (JPEG) format on the image data. In a case of the video, the image processing unit 27 performs, for example, compression processing of a moving picture experts group (MPEG) format on the image data. The image processing unit 27 outputs the image data, which has been subjected to the compression processing, to the media controller 31.

The media controller 31 records the image data, which has been subjected to the compression processing, from the image processing unit 27 in a memory card 35. The memory card 35 is attachably and detachably mounted in a memory card slot (not shown).

In a case where an image playback mode is selected via a mode selector switch of the operation unit 21, the media controller 31 reads out the image data from the memory card 35 to output the read out image data to the image processing unit 27. The image processing unit 27 performs decompression processing on the image data from the memory card 35. The image processing unit 27 outputs the image data, which has been subjected to the decompression processing, to the display controller 30. The display controller 30 converts the image data into the video data to output the converted video data to the rear monitor 34. Accordingly, the user can visually recognize a playback image through the rear monitor 34.

The instruction receiving unit 32 receives various operation instructions input from the user via a touch panel 36 that is integrally provided with the operation unit 21 and the rear monitor 34. The instruction receiving unit 32 outputs the received various operation instructions to the controller 20 through the busline 28.

As described above, the operation unit 21 includes the angle-of-view change switch, the release button, and the mode selector switch. The release button is a two-stage press button for performing a half-press operation and the full-press operation. An instruction to prepare the capturing of the still image or the video is issued by the half-press operation on the release button, and the instruction to start the capturing of the still image or the video is issued by the full-press operation of the release button. In addition to these buttons, the operation unit 21 further includes a menu button for displaying various setting menus on the rear monitor 34, a cross key used for numerical value setting and switching of options, a confirm button that is operated in a case of confirming the setting, and the like. The touch panel 36 is superimposed on a display surface of the rear monitor 34. The touch panel 36 detects the contact with a finger of the user or a dedicated indicator such as a stylus pen, to recognize the various operation instructions from the user.

The modes that can be switched by the mode selector switch include a static-image capturing mode, a video imaging mode, an image playback mode, a setting mode, and the like. The still image capturing mode includes not only a normal imaging mode in which one still image is captured but also a consecutive imaging mode in which the still images are consecutively captured at a predetermined imaging interval (for example, a frame rate of 5 fps to 10 fps). The consecutive imaging mode is activated, for example, in a case where a fully-pressed state of the release button continues for a predetermined time or longer (for example, one second or longer). The continuous capturing mode ends in a case where the full push state of the release button is released.

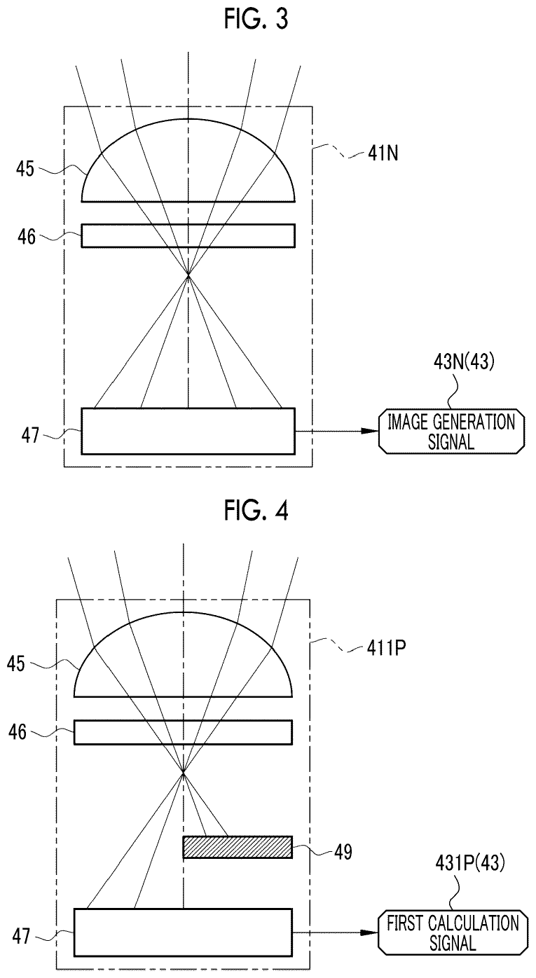

As shown in FIG. 2 as an example, the imaging element 12 is provided with a photoelectric conversion unit 40. The photoelectric conversion unit 40 is formed by a plurality of pixels 41 two-dimensionally arranged along an X-direction and a Y-direction. The plurality of pixels 41 form the imaging surface 42. As is well known, the pixel 41 is formed by a micro lens 45, a color filter 46, and a photoelectric conversion element 47 such as a photodiode (see FIGS. 3 to 5). It should be noted that the X-direction and the Y-direction are the horizontal direction and the vertical direction in a state in which a bottom surface of the imaging apparatus 10 is placed on a horizontal plane. In particular, the X direction is an example of a “phase-difference detection direction” according to the technology of the present disclosure. In this example, the Y direction is also the “phase-difference detection direction”.

Scanning lines parallel to the X direction are wired between rows of the pixels 41. Further, a signal line parallel to the Y-direction is wired between columns of the pixels 41. The pixel 41 (photoelectric conversion element 47 thereof) is connected to the signal line via an amplifier and a switch. The scanning line is also connected to the switch. In a case of an accumulation operation that accumulates a signal charge in accordance with the subject light in the pixel 41 (photoelectric conversion element 47 thereof), an OFF signal is supplied as the vertical scanning signal through the scanning line to turn off the switch. In a case of a readout operation that reads out an image signal (voltage signal) 43 in accordance with the signal charge from the pixel 41 (photoelectric conversion element 47 thereof), an ON signal is supplied as the vertical scanning signal through the scanning line to turn on the switch. A terminal of the signal line is connected to a correlated double sampling (CDS) circuit and an analog-to-digital converter (ADC) circuit. The CDS circuit performs sampling two correlation pile on the image signal 43 input through the signal line. The ADC circuit converts the image signal 43, which has been subjected to the sampling two correlation pile, into a digital image signal 43.

The pixels 41 are divided, depending on types of the color filter 46, into three types of a green pixel (denoted by “G” in FIG. 2) having sensitivity to light in a green wavelength range, a red pixel (denoted by “R” in FIG. 2) having sensitivity to light in a red wavelength range, and a blue pixel (denoted by “B” in FIG. 2) having sensitivity to light in a blue wavelength range. The three types of the pixels 41 are regularly arranged in a predetermined array. As the predetermined array, a so-called Bayer array is exemplified in which two green pixels, one blue pixel, and one red pixel are arranged in vertical and horizontal 2×2 pixels.

The pixels 41 include a normal pixel 41N and a phase-difference detection pixel 41P. The phase-difference detection pixels 41P further include a first phase-difference detection pixel 411P and a second phase-difference detection pixel 412P. The normal pixel 41N has three types of pixels of a green pixel, a blue pixel, and a red pixel, but the phase-difference detection pixel 41P has only the green pixel.

The phase-difference detection pixels 41P are arranged at predetermined intervals in the X-direction and the Y-direction. In FIG. 2, the phase-difference detection pixels 41P are arranged at an interval of five pixels in the X-direction and at an interval of two pixels in the Y-direction. Further, as the phase-difference detection pixels 41P, the first phase-difference detection pixel 411P and the second phase-difference detection pixel 412P are arranged to alternately appear in the X-direction and the Y-direction. For example, in a case of a fourth row, the phase-difference detection pixels 41P are arranged, from left to right, in an order of the second phase-difference detection pixel 412P, the first phase-difference detection pixel 411P, and the like. Further, for example, in a case of a tenth column, the phase-difference detection pixels 41P are arranged, from top to bottom, in an order of the second phase-difference detection pixel 412P, the first phase-difference detection pixel 411P, the second phase-difference detection pixel 412P, the first phase-difference detection pixel 411P, and the like. The first phase-difference detection pixel 411P and the second phase-difference detection pixel 412P adjacent to each other in the X-direction and the Y-direction constitute one set for detecting a phase difference α (see FIG. 6).

As shown in FIGS. 3 to 5 as an example, the normal pixel 41N, the first phase-difference detection pixel 411P, and the second phase-difference detection pixel 412P have the same basic configuration, and are formed by the micro lens 45, the color filter 46, and the photoelectric conversion element 47, which are disposed in order from the object side.

As shown in FIG. 3, the photoelectric conversion element 47 of the normal pixel 41N outputs, as the image signal 43, an image generation signal 43N in accordance with the subject light that is condensed by the micro lens 45 and transmitted through the color filter 46. The image generation signal 43N is stored in the image memory 26 as a part of the image data.

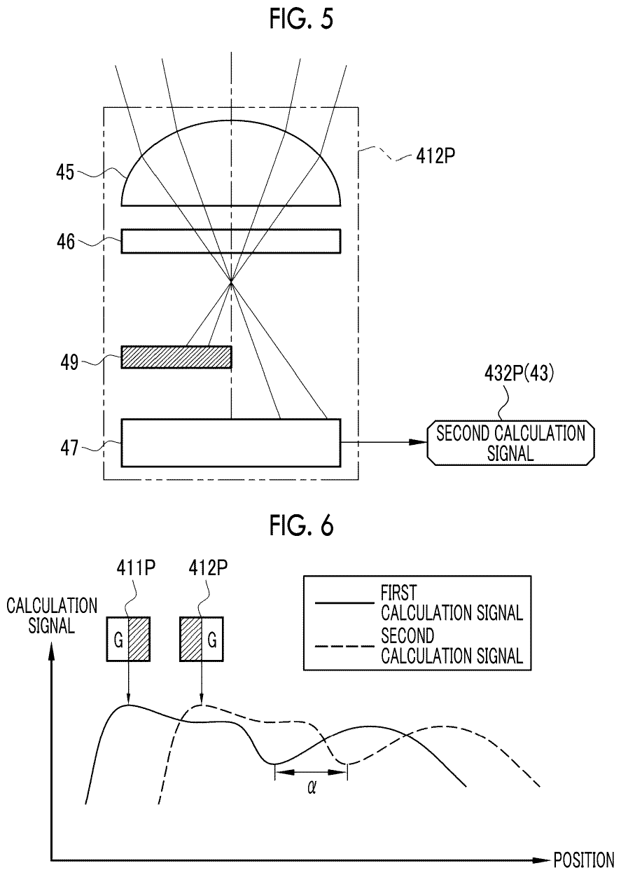

As shown in FIGS. 4 and 5, a light shielding member 49 is disposed between the color filter 46 and the photoelectric conversion element 47 of the first phase-difference detection pixel 411P and the second phase-difference detection pixel 412P. The light shielding member 49 is not disposed in the normal pixel 41N. The light shielding member 49 of the first phase-difference detection pixel 411P shields a right half of the photoelectric conversion element 47, as seen from the object side. On the contrary, the light shielding member 49 of the second phase-difference detection pixel 412P shields a left half of the photoelectric conversion element 47, as seen from the object side.

The photoelectric conversion element 47 of the first phase-difference detection pixel 411P outputs, as the image signal 43, a first calculation signal 431P in accordance with the subject light that is condensed by the micro lens 45 and transmitted through the color filter 46, and that has the right half shielded by the light shielding member 49. On the contrary, the photoelectric conversion element 47 of the second phase-difference detection pixel 412P outputs, as the image signal 43, a second calculation signal 432P in accordance with the subject light that is condensed by the micro lens 45 and transmitted through the color filter 46, and that has the left half shielded by the light shielding member 49. The first calculation signal 431P and the second calculation signal 432P are stored in the image memory 26 as a part of the image data, as in the image generation signal 43N. The first calculation signal 431P and the second calculation signal 432P are examples of a “pixel value of the phase-difference detection pixel” according to the technology of the present disclosure. It should be noted that, hereinafter, in a case where there is no need to particularly distinguish the signals from each other, the first calculation signal 431P and the second calculation signal 432P are collectively referred to as a calculation signal 43P.

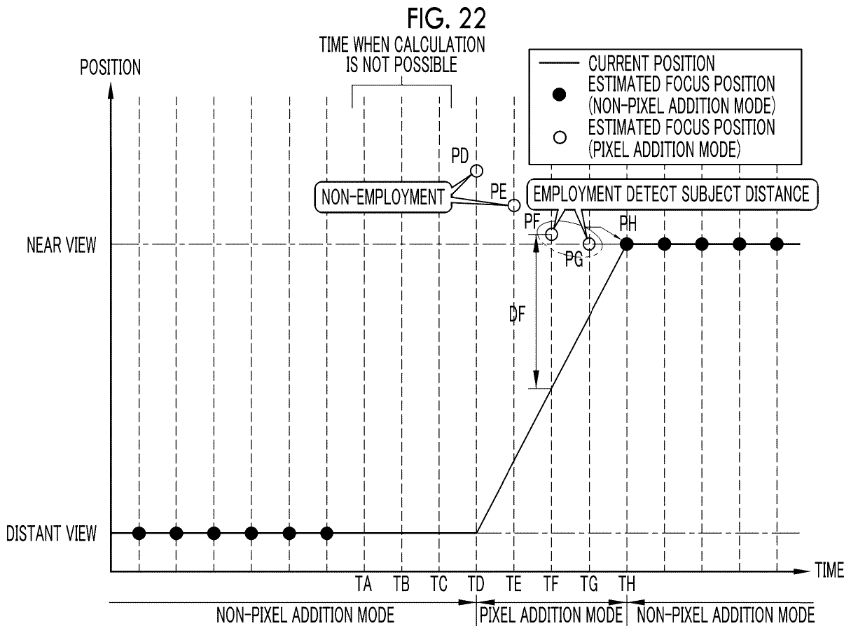

As shown in FIG. 6 as an example, the phase difference α appears between the first calculation signal 431P and the second calculation signal 432P, which are output from the first phase-difference detection pixel 411P and the second phase-difference detection pixel 412P adjacent to each other in the X-direction and the Y-direction. The phase difference α is also referred to as parallax. With the phase difference α, it is possible to know a moving direction and a moving amount of the focus lens 14 for obtaining a focusing position. The imaging apparatus 10 calculates a defocus amount DF (see FIG. 22) based on the phase difference α and performs an automatic focusing control of automatically moving the focus lens 14 to a position where the defocus amount DF is reduced, more specifically, a position where the defocus amount DF is 0. The defocus amount DF is a difference between the position of the focus lens 14 on the optical axis OA, that is, the current position of the focus lens 14 and the focusing position. The defocus amount DF is an example of a “focusing evaluation value” according to the technology of the present disclosure.

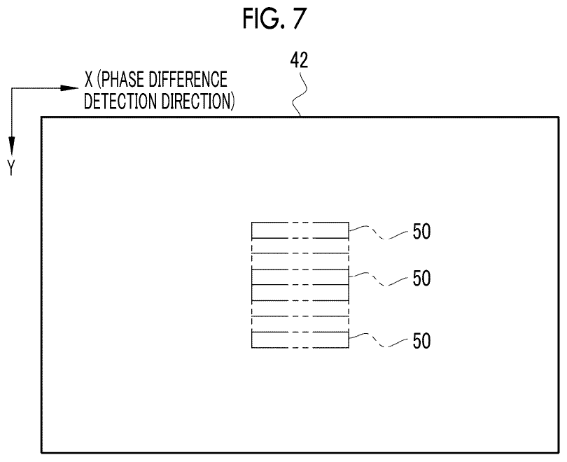

As shown in FIG. 7 as an example, a region (hereinafter, referred to as a focus adjustment region) 50 in which the defocus amount DF is calculated is set in advance in a central portion of the imaging surface 42. The focus adjustment region 50 is a long rectangular region in the X direction which is the phase-difference detection direction. A plurality of focus adjustment regions 50, here, eight focus adjustment regions 50 are set. The focus adjustment region 50 is an example of “set region” according to the technology of the present disclosure.

In addition, the focus adjustment region 50 may be a region designated by the user, or a region surrounding a specific subject recognized by a well-known subject recognition technology. The specific subject is a pupil, a face, or a body of a person, a pupil, a face, or a body of an animal, or a head, a body, or the like of a vehicle such as an automobile, a railway vehicle, or an airplane. Here, the pupil of the person or the animal is a pupil, that is, a so-called iris. The face of the person or the animal is a portion having, for example, a forehead, a cheek, a chin, eyes, a nose, a mouth, and ears. The body of the person or the animal is a portion excluding a head, a neck, limbs, and a tail. The head of the vehicle is a front body in a case of the automobile, a portion of a head car having a destination display, a front window, a headlight, or the like in a case of the railway car, and a nose portion having a radome, front window, or the like in a case of the airplane. The body of the vehicle is the entire body excluding wheels in a case of the automobile, the entire body excluding wheels in a case of the railway car regardless of whether the car is a head car, an intermediate car, or a last car, and the entire body excluding a head, main wings, a caudal wing, and the like in a case of the airplane.

The image generation signal 43N is used to generate an image such as the live view image, as known from the name thereof. The calculation signal 43P is used only for calculating the phase difference α and thus the defocus amount DF, and is not used for generating the captured image. Therefore, in the pixel interpolation processing, the image processing unit 27 interpolates a pixel value of the phase-difference detection pixel 41P by using the image generation signals 43N of the normal pixels 41N around the phase-difference detection pixel 41P.

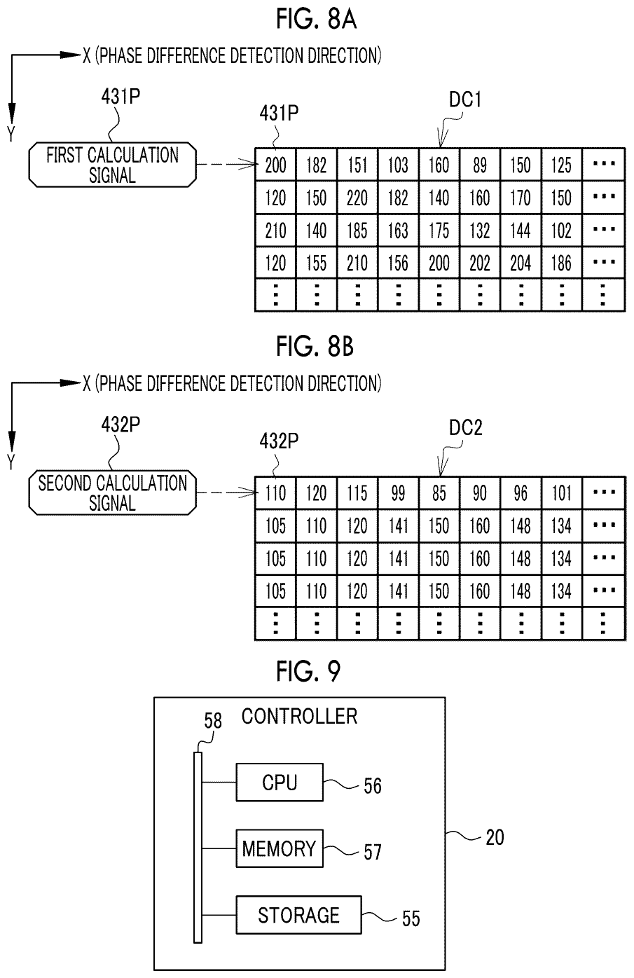

Here, the calculation signal 43P is specifically divided into, for example, first calculation data DC1 illustrated in FIG. 8A and second calculation data DC2 illustrated in FIG. 8B. The first calculation data DC1 is data in which a plurality of first calculation signals 431P output from the first phase-difference detection pixel 411P are two-dimensionally arranged in the X direction and the Y direction in accordance with the disposition of the first phase-difference detection pixel 411P. The second calculation data DC2 is data in which a plurality of second calculation signals 432P output from the second phase-difference detection pixel 412P are two-dimensionally arranged in the X direction and the Y direction in accordance with the disposition of the second phase-difference detection pixel 412P. The first calculation data DC1 and the second calculation data DC2 can be handled as two-dimensional image data. In the following, in a case where it is not necessary to distinguish between the first calculation data DC1 and the second calculation data DC2, the first calculation data DC1 and the second calculation data DC2 are collectively referred to as calculation data DC.

As shown in FIG. 9 as an example, the controller 20 comprises a storage 55, a central processing unit (CPU) 56, and a memory 57. The storage 55, the CPU 56, and the memory 57 are connected to each other through a busline 58. The controller 20 is an example of a “focusing control device”and a “computer”according to the technology of the present disclosure.

The storage 55 is a non-volatile storage device, such as an electrically erasable programmable read-only memory (EEPROM). The storage 55 stores various programs, various types of data associated with the various programs, and the like. It should be noted that, instead of the EEPROM, a ferroelectric random-access memory (FeRAM) or a magnetoresistive random-access memory (MRAM) may be used as the storage 55.

The memory 57 is a work memory for the CPU 56 to execute processing. The CPU 56 loads the program stored in the storage 55 into the memory 57 to execute the loaded processing in accordance with the program. As a result, the CPU 56 controls the respective units of the imaging apparatus 10 in an integrated manner. The CPU 56 is an example of a “processor” according to the technology of the present disclosure. It should be noted that the memory 57 may be built in the CPU 56.

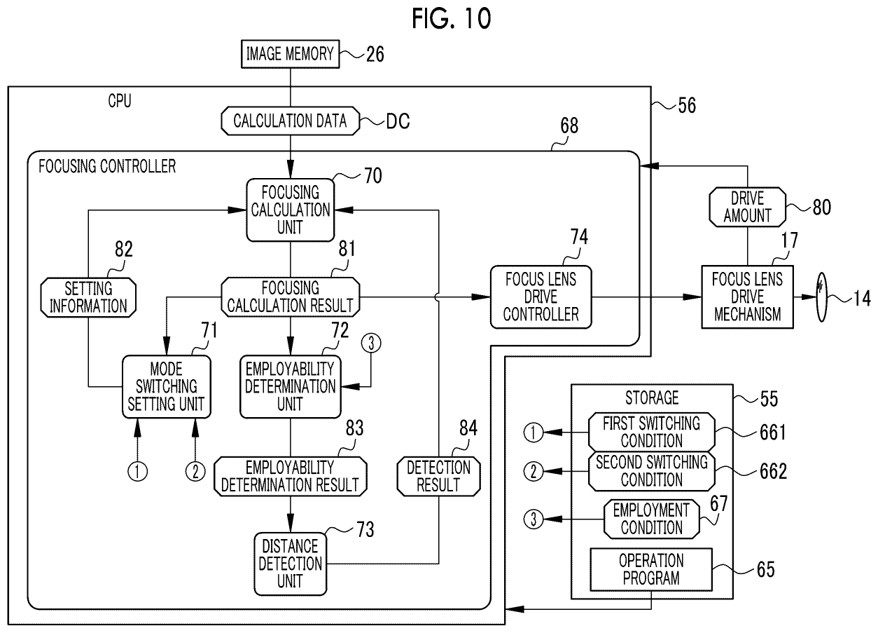

As shown in FIG. 10 as an example, an operation program 65 is stored in the storage 55. The operation program 65 is a program causing the CPU 56 to perform the automatic focusing control and the like. That is, the operation program 65 is an example of an “operation program of a focusing control device” according to the technology of the present disclosure. The storage 55 also stores a first switching condition 661, a second switching condition 662, and an employment condition 67. The employment condition 67 is an example of a “condition” according to the technology of the present disclosure.

In a case where the operation program 65 is activated, the CPU 56 functions as the focusing controller 68 in cooperation with the memory 57 and the like. The focusing controller 68 includes a focusing calculation unit 70, a mode switching setting unit 71, an employability determination unit 72, a distance detection unit 73, and a focus lens driving controller 74. The CPU 56 also functions as various processing units in addition to the focusing controller 68.

The focusing controller 68 receives the drive amount 80 of the focus motor from the focus lens drive mechanism 17. The focusing controller 68 derives the current position of the focus lens 14 from the drive amount 80.

The focusing calculation unit 70 reads out the calculation data DC from the image memory 26. The focusing calculation unit 70 detects the phase difference α shown in FIG. 6 from the calculation data DC of the focus adjustment region 50. The focusing calculation unit 70 converts the phase difference α into the defocus amount DF. The focusing calculation unit 70 outputs the focusing calculation result 81 including the calculated defocus amount DF to the mode switching setting unit 71, the employability determination unit 72, and the focus lens driving controller 74. Since a method of converting the phase difference α into the defocus amount DF is known, the detailed description thereof will be omitted here.

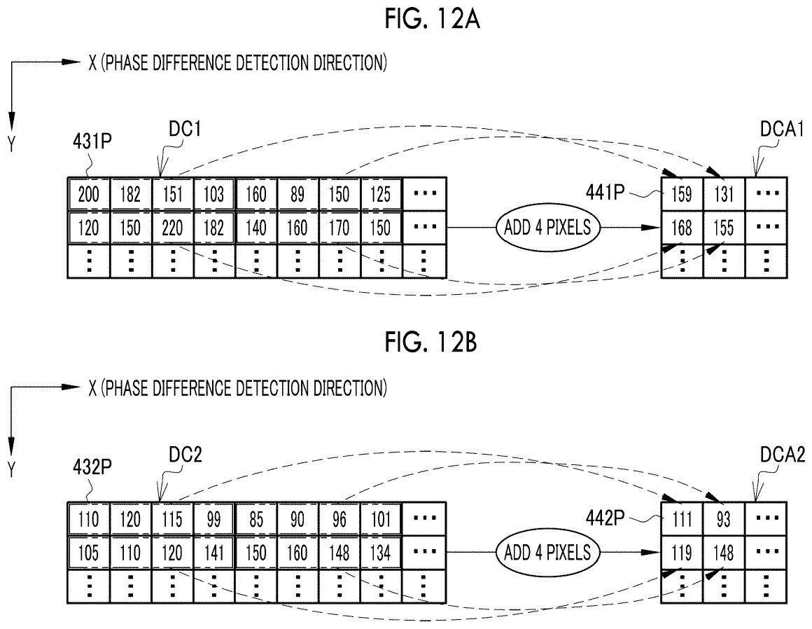

The first switching condition 661 and the second switching condition 662 are input to the mode switching setting unit 71. The mode switching setting unit 71 sets any one of two modes of the non-pixel addition mode and the pixel addition mode based on the first switching condition 661, the second switching condition 662, and the focusing calculation result 81. The non-pixel addition mode is a mode in which the calculation signal 43P, which is the pixel value of the calculation data DC, is used as it is without being added. The pixel addition mode is a mode in which the calculation signal 43P is added (refer to FIGS. 12A and 12B). The mode switching setting unit 71 outputs the setting information 82 of the mode to the focusing calculation unit 70.

The employment conditions 67 are input to the employability determination unit 72. The employability determination unit 72 determines whether or not to employ the defocus amount DF included in the focusing calculation result 81 output in the pixel addition mode as the suitable defocus amount ADF based on the employment condition 67. The suitable defocus amount ADF is a defocus amount DF used for detection of a distance (hereinafter, referred to as a subject distance) to a target subject in the distance detection unit 73 and focusing control. The suitable defocus amount ADFA is an example of a “focusing evaluation value satisfying a predetermined condition”according to the technology of the present disclosure.

The subject distance is, for example, a distance from the imaging surface 42 to the target subject. The target subject is a subject that is present in the focus adjustment region 50. The employability determination unit 72 outputs the employability determination result 83 to the distance detection unit 73.

The employability determination unit 72 outputs the focusing calculation result 81 output in the non-pixel addition mode to the distance detection unit 73 without performing the determination. The distance detection unit 73 unconditionally treats the defocus amount DF included in the focusing calculation result 81 output in the non-pixel addition mode as the suitable defocus amount ADF, and uses the suitable defocus amount ADF for the detection of the subject distance.

The distance detection unit 73 detects the subject distance from the suitable defocus amount ADF. The suitable defocus amount ADF handled by the distance detection unit 73 is calculated, for example, 1 to 3 frames before. The subject distance detected by the distance detection unit 73 is, for example, a distance corresponding to a position at which the subject is predicted to be present in the next frame. In other words, the distance detection unit 73 predicts the future subject distance from the defocus amount DF calculated in the past. The distance detection unit 73 stocks a defocus amount DF of a predetermined number (hereinafter, referred to as the required number) of the defocus amounts DF necessary for detecting the subject distance for a plurality of consecutive frames. Since a method of detecting the subject distance from the defocus amount DF is known, detailed description thereof will be omitted here. The distance detection unit 73 outputs the detection result 84 of the subject distance to the focusing calculation unit 70.

The focus lens driving controller 74 controls the drive of the focus lens drive mechanism 17 and thus the focus lens 14. Specifically, the focus lens driving controller 74 moves the focus lens 14 to the estimated focus position corresponding to the calculated defocus amount DF from the current position derived based on the drive amount 80 via the focus lens drive mechanism 17. Here, the phrase “the focus lens driving controller 74 moves the focus lens 14” strictly means issuing the drive signal from the focus lens driving controller 74 to the driver of the focusing motor of the focus lens drive mechanism 17 to move the focus lens 14 via the focusing motor. In a case where the current position of the focus lens 14 and the estimated focus position are the same (the defocus amount DF is 0), the focus lens driving controller 74 does nothing, and the focus lens 14 is not moved.

The focusing controller 68 performs the focusing calculation by the focusing calculation unit 70 and the driving control of the focus lens 14 by the focus lens driving controller 74 for each frame. Therefore, the focusing calculation result 81 by the focusing calculation unit 70 is updated for each frame. Therefore, the number of times of output of the focusing calculation result 81 per unit time is 1 time/frame.

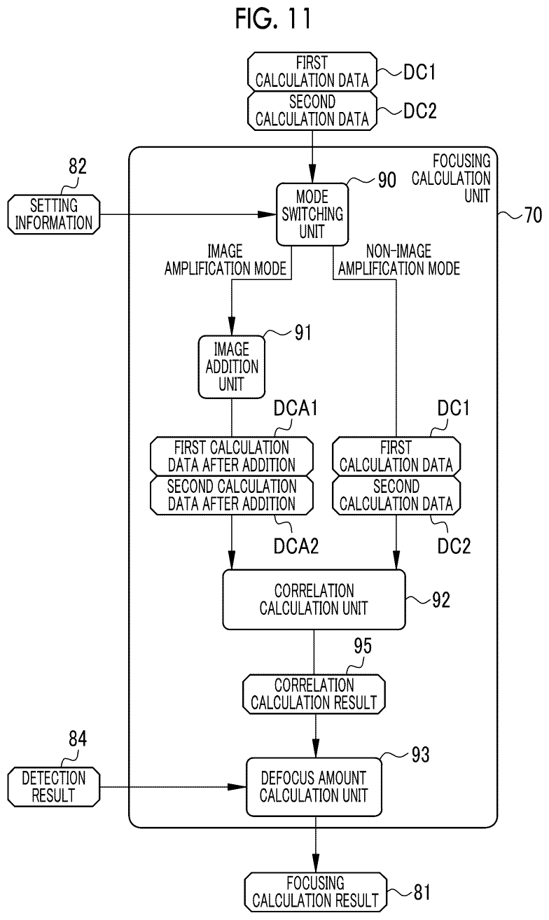

As an example, as shown in FIG. 11, the focusing calculation unit 70 includes a mode switching unit 90, a pixel addition unit 91, a correlation calculation unit 92, and a defocus amount calculation unit 93. The first calculation data DC1, the second calculation data DC2, and the setting information 82 are input to the mode switching unit 90. In a case where the content of the setting information 82 is to set the non-pixel addition mode, the mode switching unit 90 outputs the first calculation data DC1 and the second calculation data DC2 to the correlation calculation unit 92. On the other hand, in a case where the content of the setting information 82 is to set the pixel addition mode, the mode switching unit 90 outputs the first calculation data DC1 and the second calculation data DC2 to the pixel addition unit 91.

A filter processing unit (not shown) is provided in front of the mode switching unit 90. The filter processing unit performs filter processing of passing the first calculation data DC1 and the second calculation data DC2 through a band-pass filter. The first calculation data DC1 and the second calculation data DC2 after the filter processing are input to the mode switching unit 90.

The pixel addition unit 91 performs pixel addition processing on the first calculation data DC1 and the second calculation data DC2 to obtain added first calculation data after addition DCA1 and second calculation data after addition DCA2. The pixel addition unit 91 outputs the first calculation data after addition DCA1 and the second calculation data after addition DCA2 to the correlation calculation unit 92. In the following, in a case where it is not necessary to distinguish between the data items, the data items of the first calculation data after addition DCA1 and the second calculation data after addition DCA2 are collectively referred to as calculation data after addition DCA.

In the non-pixel addition mode, the correlation calculation unit 92 performs the correlation calculation of the first calculation data DC1 and the second calculation data DC2. In the pixel addition mode, the correlation calculation unit 92 performs the correlation calculation of the first calculation data after addition DCA1 and the second calculation data after addition DCA2. The correlation calculation unit 92 outputs the correlation calculation result 95 to the defocus amount calculation unit 93.

The defocus amount calculation unit 93 calculates the defocus amount DF based on the correlation calculation result 95. In addition, in a case where the detection result 84 from the distance detection unit 73 is input, the defocus amount calculation unit 93 calculates the defocus amount DF corresponding to the subject distance included in the detection result 84.

As an example, as shown in FIG. 12A, the pixel addition unit 91 generates the first calculation data after addition DCA1 by repeating processing of adding and averaging the first calculation signal 431P for four pixels connected in the X direction, which is the phase-difference detection direction, as the pixel addition processing. In the same manner, as shown in (B), the pixel addition unit 91 generates the second calculation data after addition DCA2 by repeating, as the pixel addition processing, processing of adding and averaging the second calculation signal 432P for four pixels that are connected in the X direction. The number of pixels of the calculation data after addition DCA is compressed to ¼ of the number of pixels of the calculation data DC. Therefore, the calculation data after addition DCA is data in which the intensity of the frequency component is pseudo-shifted to the high frequency side. The first calculation signal after addition 441P for the first calculation data after addition DCA1 and the second calculation signal after addition 442P for the second calculation data after addition DCA2 are examples of an “added value” according to the technology of the present disclosure.

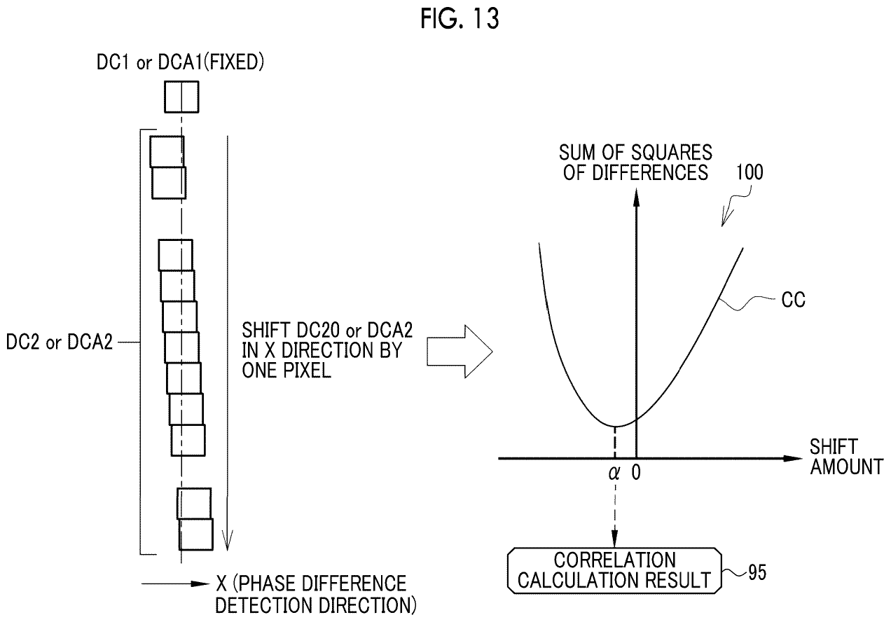

As shown in FIG. 13 as an example, in a case of the non-pixel addition mode, the correlation calculation unit 92 fixes the first calculation data DC1 of the focus adjustment region 50 and shifts the second calculation data DC2 of the focus adjustment region 50 one pixel by the X direction which is the phase-difference detection direction. Then, each time the focus adjustment region 50 is shifted, a sum of squares of differences between the first calculation data DC1 and the second calculation data DC2 of the focus adjustment region 50 is calculated. On the other hand, in the pixel addition mode, the correlation calculation unit 92 fixes the first calculation data after addition DCA1 after focusing in the focus adjustment region 50 and shifts the second calculation data after addition DCA2 after focusing in the focus adjustment region 50 in the X direction by one pixel. Then, each time the focus adjustment region 50 is shifted, a sum of squares of differences between the first calculation data after addition DCA1 and the second calculation data after addition DCA2 is calculated. Instead of the sum of squares of differences, a sum of absolute values of differences or normalized mutual correlation may be calculated.

A graph 100 is a graph in which a shift amount of the second calculation data DC2 or the second calculation data after addition DCA2 is plotted on a horizontal axis and a sum of squares of differences is plotted on a vertical axis. In the graph 100, the correlation curve CC is a line connecting the plots of the sum of squares of differences at each shift amount. In the correlation curve CC, the shift amount, that is, the phase difference α at which the sum of squares of differences is minimum is the phase difference α. The correlation calculation unit 92 outputs a correlation calculation result 95 including the phase difference α.

The correlation calculation unit 92 performs the above-described correlation calculation for each focus adjustment region 50. Therefore, a plurality of correlation curves CC for each focus adjustment region 50, in this example, eight correlation curves CC are obtained. The correlation calculation unit 92 aggregates the plurality of correlation curves CC into one correlation curve CC by, for example, additive averaging the plurality of correlation curves CC. Then, the phase difference α is detected from the aggregated one correlation curve CC.

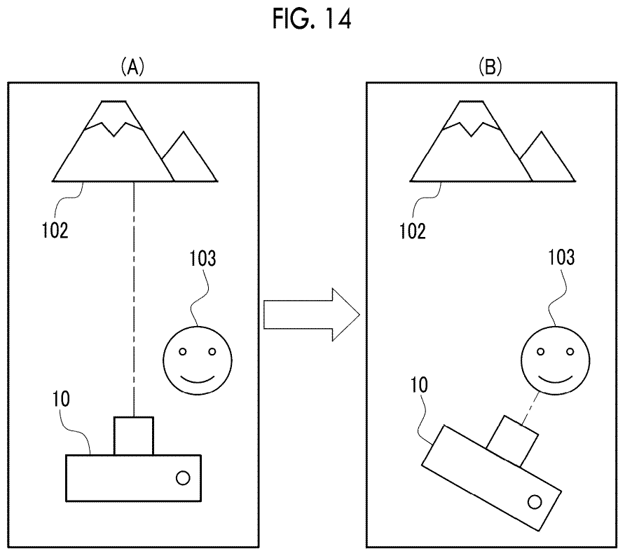

Here, a scene shown in FIG. 14 is considered as an example. That is, (A) shows a case where the video is captured using a mountain 102 in a distant view as the subject. As shown in (B) from a state shown in (A), in a case where the subject is switched from the mountain 102 in the distant view to a person 103 in a near view, a subject distance is changed greatly.

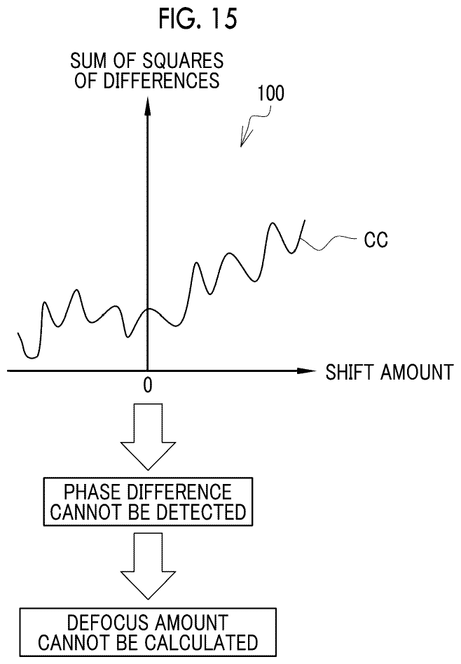

In a case where the subject distance is largely changed as in FIG. 14, the focus lens 14 may not be able to follow the movement to the estimated focus position, and the state may be largely blurred. In such a significantly blurred state, as shown in FIG. 15 as an example, the waveform of the correlation curve CC obtained by the correlation calculation between the first calculation data DC1 and the second calculation data DC2 is disturbed, and a plurality of minimum values of the sum of squares of differences appear. From such a correlation curve CC, the phase difference α cannot be detected, and therefore, the defocus amount DF cannot be calculated.

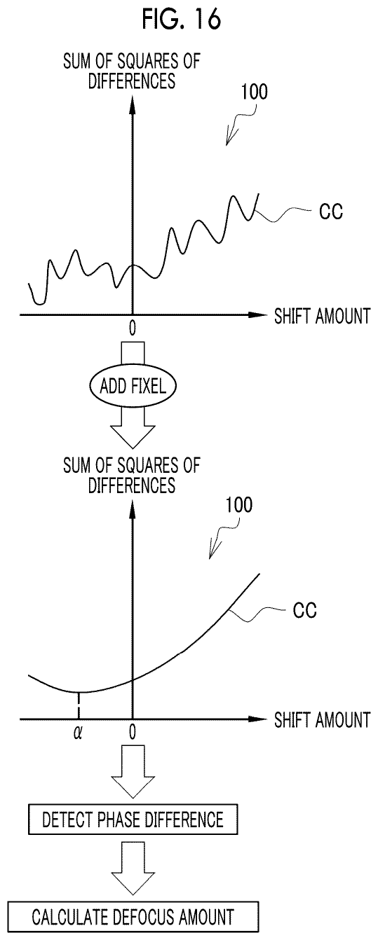

On the other hand, as an example, as illustrated in FIG. 16, by performing the pixel addition processing, the correlation curve CC obtained by the correlation calculation between the first calculation data after addition DCA1 and the second calculation data after addition DCA2 is a curve in which the fluctuation of the waveform is settled. As a result, it is possible to detect the phase difference α, and thus it is also possible to calculate the defocus amount DF. However, since the calculation data after addition DCA compresses the pixel value, the calculation accuracy of the defocus amount DF is lower than that in a non-pixel addition mode in which the calculation data DC is used. As described above, the pixel addition mode is provided in order to escape from a situation in which the subject distance is largely changed and the state is largely blurred, and the defocus amount DF cannot be calculated and the automatic focusing control cannot be performed. Therefore, in the pixel addition mode, the slight decrease in the calculation accuracy of the defocus amount DF is not taken into consideration.

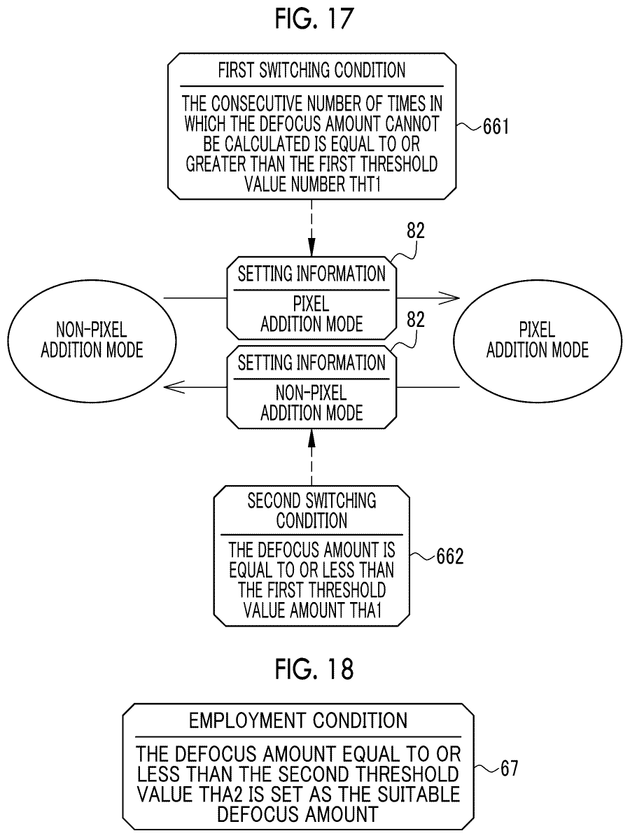

As shown in FIG. 17 as an example, the first switching condition 661 is that the consecutive number of times in which the defocus amount DF cannot be calculated in the defocus amount calculation unit 93 is equal to or greater than a first threshold value number THT1. The first threshold value number THT1 is, for example, three. In a case where the first switching condition 661 is satisfied in the non-pixel addition mode, the mode switching setting unit 71 outputs setting information 82 indicating to set the pixel addition mode. Accordingly, the mode switching unit 90 switches the mode from the non-pixel addition mode to the pixel addition mode.

The second switching condition 662 is that the defocus amount DF calculated by the defocus amount calculation unit 93 is equal to or less than the first threshold value amount THA1. The first threshold value amount THA1 is, for example, 1/10 of the maximum value of the defocus amount DF. The mode switching setting unit 71 outputs the setting information 82 having the content that the non-pixel addition mode is set in a case where the second switching condition 662 is satisfied in the pixel addition mode. Accordingly, the mode switching unit 90 switches the mode from the pixel addition mode to the non-pixel addition mode.

As shown in FIG. 18 as an example, the employment condition 67 is a content that the defocus amount DF equal to or less than the second threshold value amount THA2 is set as the suitable defocus amount ADF. The second threshold value amount THA2 is a value larger than the first threshold value amount THA1, and is, for example, ⅕ of the maximum value of the defocus amount DF. The second threshold value amount THA2 is an example of a “first threshold value” according to the technology of the present disclosure. In addition, the second threshold value amount THA2 or less is an example of “within the first threshold value range” according to the technology of the present disclosure.

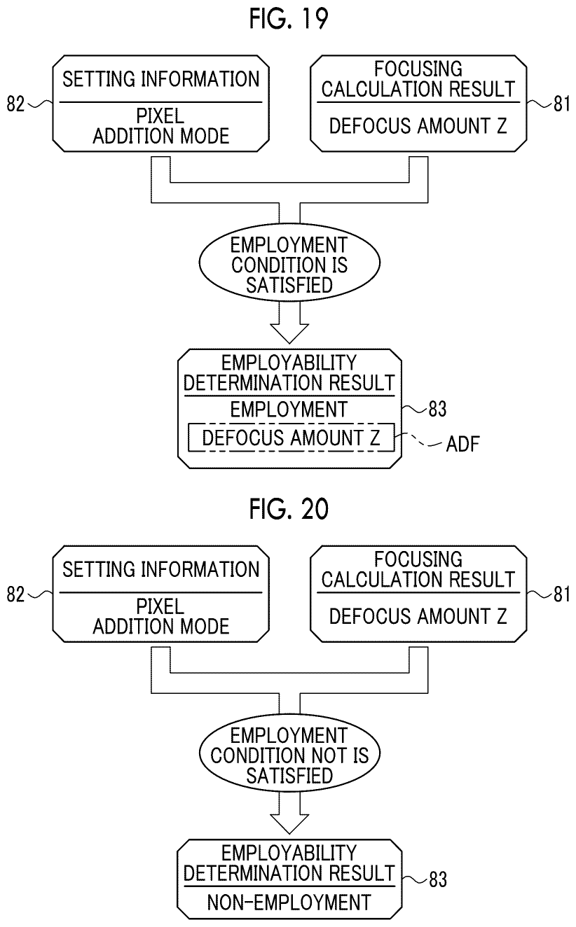

As shown in FIG. 19 as an example, in the pixel addition mode, in a case where the defocus amount DF (in FIG. 19, denoted by a defocus amount Z, the same applies to FIG. 20) is calculated from the defocus amount calculation unit 93 and the defocus amount DF satisfies the employment condition 67, the employability determination unit 72 outputs the employability determination result 83 indicating that the defocus amount DF is employed as the suitable defocus amount ADF. In this case, the employability determination unit 72 includes the defocus amount DF in the employability determination result 83.

On the other hand, as an example, as shown in FIG. 20, in the pixel addition mode, in a case where the defocus amount DF is calculated from the defocus amount calculation unit 93, but the defocus amount DF does not satisfy the employment condition 67, the employability determination unit 72 outputs the employability determination result 83 indicating non-employment.

As shown in FIGS. 19 and 20, in a case where the defocus amount DF is calculated from the defocus amount calculation unit 93, the focusing calculation result 81 includes the calculated defocus amount DF. On the other hand, in a case where the defocus amount DF cannot be calculated, the focusing calculation result 81 naturally does not include the defocus amount DF and indicates that the defocus amount DF cannot be calculated.

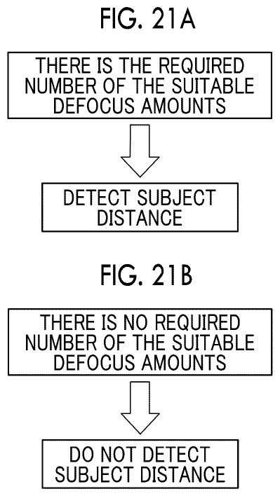

As shown in FIG. 21A as an example, in a case where there are the required number of suitable defocus amounts ADF, the distance detection unit 73 detects the subject distance. On the other hand, as shown in (B), in a case where there is no required number of the suitable defocus amount ADF, the distance detection unit 73 does not perform the detection of the subject distance. The required number varies depending on the mode. Specifically, the required number of pixels in the pixel addition mode is 2, and the required number of pixels in the non-pixel addition mode is 3.

FIG. 22 shows transitions of the current position and the estimated focus position of the focus lens 14 in a case where the subject is switched from the distant view to the near view in the time TA of the non-pixel addition mode. The case where the subject is switched from the distant view to the near view is a scene where the subject distance significantly changes as shown in FIG. 14. In such a case, the defocus amount DF cannot be calculated as shown in FIG. 15. Therefore, at the time TA, the defocus amount DF cannot be calculated, and the estimated focus position cannot be detected.

Even in the time TB and the time TC after the time TA, the state in which the defocus amount DF cannot be calculated continues. In a case where a state in which the defocus amount DF cannot be calculated continues three times and the first switching condition 661 is satisfied, the mode is switched from the non-pixel addition mode to the pixel addition mode by the mode switching unit 90 as shown in FIG. 17.

In the first time TD after the switching to the pixel addition mode, the defocus amount DF is calculated from the defocus amount calculation unit 93, and the estimated focusing position PD is detected. In the pixel addition mode, since the calculation accuracy of the defocus amount DF is decreased, the estimated focusing position PD deviates from the original focusing position of the near view indicated by the one-dot chain line. Under the control of the focus lens driving controller 74, the movement of the focus lens 14 toward the estimated focus position PD is started at a predetermined speed in order to reduce the defocus amount DF.

Since the current position of the focus lens 14 and the estimated focus position PD are far apart from each other at the time TD, the defocus amount DF calculated at the time TD does not satisfy the employment condition 67. Therefore, in the employability determination unit 72, as shown in FIG. 20, it is determined that the defocus amount DF calculated at the time TD is not employed as the suitable defocus amount ADF.

Even in the subsequent time TE, the defocus amount DF is calculated from the defocus amount calculation unit 93, and the estimated focus position PE is detected. However, since the current position of the focus lens 14 and the estimated focus position PD are still far apart from each other, the defocus amount DF does not satisfy the employment condition 67. Therefore, the employability determination unit 72 determines that the defocus amount DF calculated at the time TE is not employed as the suitable defocus amount ADF.

the blurred state is gradually resolved as the focus lens 14 moves to the estimated focus position. As a result, the detection accuracy of the phase difference α and the calculation accuracy of the defocus amount DF are recovered, and the estimated focusing position gradually converges to the original focusing position. Therefore, at the time TE, the estimated focusing position PE closer to the original focusing position than the estimated focusing position PD at the time TD is updated.

At the time TF, the defocus amount DF is calculated from the defocus amount calculation unit 93, and the estimated focusing position PF closer to the original focus position is detected. The defocus amount DF in this case satisfies the employment condition 67. Therefore, in the employability determination unit 72, as shown in FIG. 19, it is determined that the defocus amount DF calculated at the time TF is employed as the suitable defocus amount ADF.

In the time period from the time TA to the time TF, there is no required number (in this case, two) of the suitable defocus amounts ADF. Therefore, as shown in FIG. 21B, the distance detection unit 73 does not detect the subject distance in the time TA to the time TF.

At the time TG, the defocus amount DF is calculated from the defocus amount calculation unit 93, and the estimated focusing position PG that is almost the same as the original focusing position is detected. The defocus amount DF in this case also satisfies the employment condition 67. Therefore, the employability determination unit 72 determines that the defocus amount DF calculated at the time TG is also employed as the suitable defocus amount ADF.

In addition, the defocus amount DF at the time TG satisfies the second switching condition 662. In a case where the second switching condition 662 is satisfied, as illustrated in FIG. 17, the mode is switched from the pixel addition mode to the non-pixel addition mode by the mode switching unit 90.

At the time TG, there are two suitable defocus amounts ADF, that is, the defocus amount DF at the previous time TF and the defocus amount DF at the time TG. Therefore, at the time TG, the distance detection unit 73 detects the subject distance as shown in FIG. 21A.

In the first time TH after the switching to the non-pixel addition mode, the defocus amount DF corresponding to the subject distance detected in the time TG is calculated from the defocus amount calculation unit 93, and the estimated focus position PH is detected. The estimated focusing position PH coincides with the original focusing position. In addition, at the time TH, the focus lens 14 reaches the estimated focus position PH. The focus lens 14 is stopped at the estimated focus position PH under the control of the focus lens driving controller 74. In this way, the focus lens 14 is moved to the estimated focus position PH, which is a position corresponding to the subject distance detected by using the defocus amounts DF at the time TF and the time TG, which are the suitable defocus amount ADF. The term “stop” does not mean that the focus lens 14 is stopped at the specific position permanently, but means that the focus lens 14 is temporarily stopped.

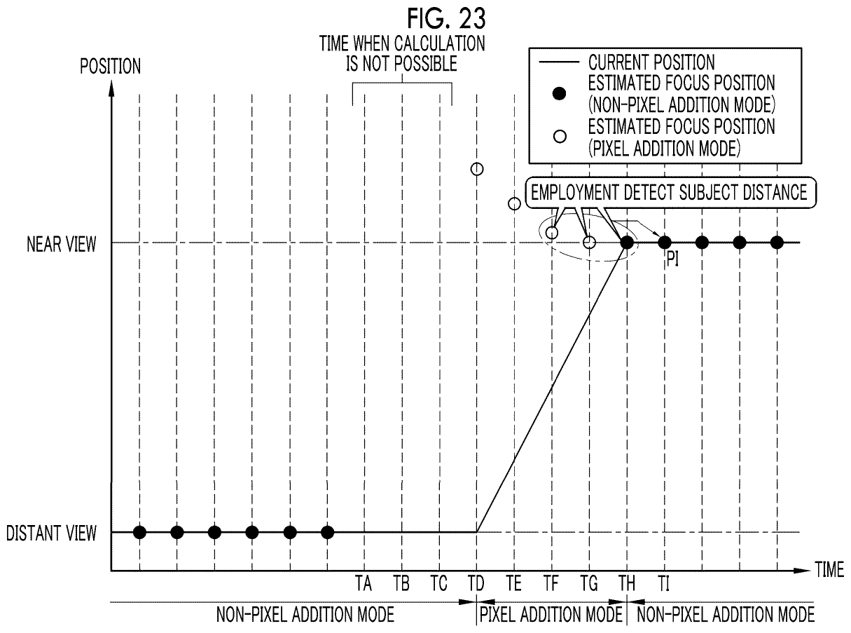

As shown in FIG. 23 as an example, there are three suitable defocus amounts ADF of the defocus amounts DF at the times TF and TG and the defocus amount DF at the time TH at the time TH. Therefore, at the time TH, the distance detection unit 73 detects the subject distance.

In the next time TI after the time TH, the defocus amount DF corresponding to the subject distance detected in the time TH is calculated from the defocus amount calculation unit 93, and the estimated focus position PI is detected. The estimated focusing position PI matches the original focusing position as in the estimated focusing position PH. The focus lens 14 is held at the estimated focus position PI under the control of the focus lens driving controller 74. As described above, even in a case where the mode is switched from the pixel addition mode to the non-pixel addition mode, the detection of the subject distance is performed by using the suitable defocus amount ADF obtained in the pixel addition mode in addition to the suitable defocus amount ADF obtained in the non-pixel addition mode.

The estimated focusing position is updated for each time, such as PD, PE, PF, PG, PH, and the like. The focus lens 14 is moved toward the estimated focus position updated every time under the control of the focus lens driving controller 74.

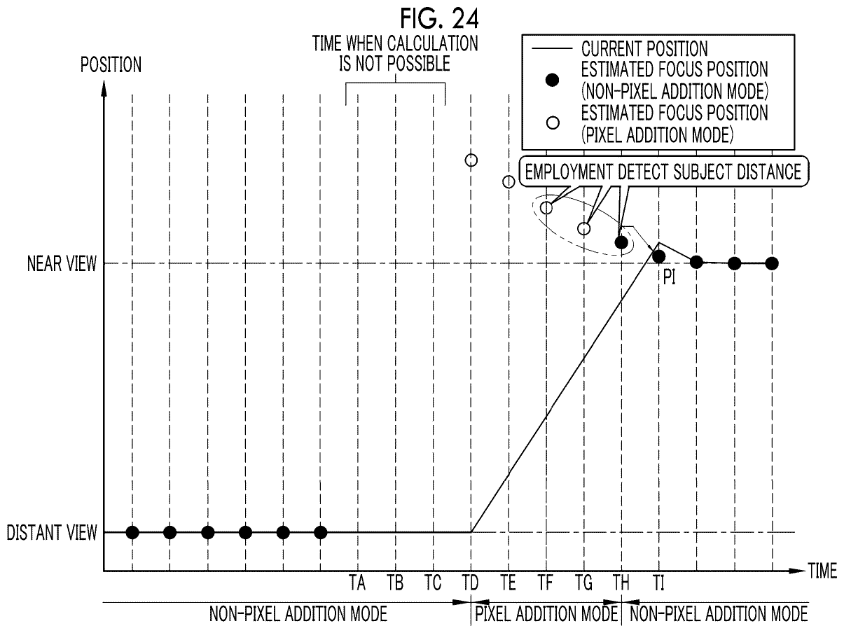

As an example, transitions of the current position and the estimated focus position of the focus lens 14 shown in FIG. 24 is a case where the subject is switched from the distant view to the near view and the subject of the near view is moving in the time TA of the non-pixel addition mode. In this case as well, for example, at the time TH, the defocus amounts DF at the times TF, TG, and TH adopted as the suitable defocus amount ADF are used to detect the subject distance. Then, at the time TI, the defocus amount DF corresponding to the subject distance detected at the time TH is calculated from the defocus amount calculation unit 93, and the estimated focusing position PI is detected. By performing the detection of the subject distance using the suitable defocus amount ADF obtained in the pixel addition mode in this way, it is possible to predict the distance corresponding to the future position of the moving subject, and thus it is easy to focus on the moving subject.

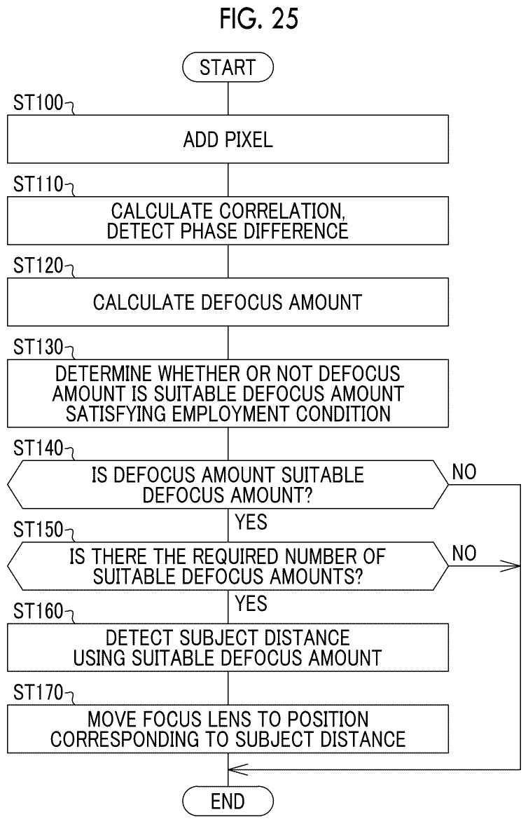

Next, an operation of the configuration described above will be described with reference to the flowchart shown in FIG. 25 as an example. As shown in FIG. 10, the CPU 56 of the control unit 20 functions as the focusing controller 68 by starting the operation program 65. The focusing controller 68 includes a focusing calculation unit 70, a mode switching setting unit 71, an employability determination unit 72, a distance detection unit 73, and a focus lens driving controller 74. Further, as shown in FIG. 11, the focusing calculation unit 70 includes a mode switching unit 90, a pixel addition unit 91, a correlation calculation unit 92, and a defocus amount calculation unit 93.

In a case where the release button is fully pressed in the video capturing mode, and the instruction receiving unit 32 receives the instruction to start the capturing of the video, the accumulation operation of the signal charge in accordance with the subject light is performed in the imaging element 12 under the control of the controller 20. Subsequently, the readout operation of the image signal 43 in accordance with the signal charge is performed. The image signal 43 is stored in the image memory 26 via the image input controller 25. The image signal 43 is subjected to various types of image processing by the image processing unit 27 and then written back to the image memory 26. Immediately after the start of the imaging of the video, the mode is set to the non-pixel addition mode by the mode switching unit 90.

The calculation data DC is read out from the image memory 26 to the focusing calculation unit 70. Then, as shown in FIG. 13, in the focusing calculation unit 70, the phase difference α is detected from the calculation data DC of the focus adjustment region 50, and the defocus amount DF is calculated from the phase difference α. The focusing calculation result 81 is output from the focusing calculation unit 70 to the mode switching setting unit 71, the employability determination unit 72, and the focus lens driving controller 74. In addition, in the focusing controller 68, the current position of the focus lens 14 is derived based on the drive amount 80 of the focus motor from the focus lens drive mechanism 17.

In a case where the first switching condition 661 is satisfied, the setting information 82 indicating that the pixel addition mode is set is output from the mode switching setting unit 71 to the focusing calculation unit 70. In the focusing calculation unit 70, the calculation data DC is output from the mode switching unit 90 to the pixel addition unit 91.

In the pixel addition unit 91, as illustrated in FIGS. 12A and 12B, the pixel addition processing is performed on the calculation data DC (step ST100). The calculation data after addition DCA is output from the pixel addition unit 91 to the correlation calculation unit 92.

In the correlation calculation unit 92, as shown in FIG. 13, the correlation calculation between the first calculation data after addition DCA1 and the second calculation data after addition DCA2 of the focus adjustment region 50 is performed, and the phase difference α is detected (step ST110). The correlation calculation result 95 is output from the correlation calculation unit 92 to the defocus amount calculation unit 93.

In the defocus amount calculation unit 93, the defocus amount DF is calculated based on the correlation calculation result 95 (step ST120).

In the employability determination unit 72, it is determined whether or not the defocus amount DF included in the focusing calculation result 81 is the suitable defocus amount ADF satisfying the employment condition 67 (step ST130). In a case where the defocus amount DF is the suitable defocus amount ADF (YES in step ST140) and there are the required number of suitable defocus amounts ADF (YES in step ST150), the subject distance is detected by the distance detection unit 73 using the suitable defocus amount ADF (step ST160). The detection result 84 of the subject distance is output from the distance detection unit 73 to the defocus amount calculation unit 93 of the focusing calculation unit 70.

In the defocus amount calculation unit 93, the defocus amount DF corresponding to the subject distance included in the detection result 84 is calculated. Then, the focus lens 14 is moved to the position corresponding to the subject distance under the control of the focus lens driving controller 74 (step ST170). That is, the focusing control is performed using the suitable defocus amount ADF.

In a case where the defocus amount DF is not the suitable defocus amount ADF (NO in step ST140) and in a case where there is no required number of suitable defocus amounts ADF (NO in step ST150), the focus lens 14 is moved to a position corresponding to the defocus amount DF calculated most recently under the control of the focus lens driving controller 74.

As described above, the imaging apparatus 10 comprises the controller 20 that is a focusing control device for performing focusing control of the focus lens 14 based on the output from the phase-difference detection pixel 41P. The CPU 56 of the controller 20 functions as a focusing controller 68. The focusing controller 68 includes a focusing calculation unit 70 and a focus lens driving controller 74.

The focusing calculation unit 70 acquires a focusing evaluation value by calculating the defocus amount DF in accordance with a first calculation signal after addition 441P and a second calculation signal after addition 442P, which are added values of the calculation signal 43P of the calculation data DC which is the pixel value of the plurality of phase-difference detection pixels 41P. The focus lens driving controller 74 performs the focusing control by using the suitable defocus amount ADF which is the defocus amount DF satisfying the employment condition 67.

The defocus amount DF calculated in the pixel addition mode has lower calculation accuracy than the defocus amount DF calculated in the non-pixel addition mode. However, the defocus amount DF calculated in the pixel addition mode may not be inferior in calculation accuracy to the defocus amount DF calculated in the non-pixel addition mode. Therefore, in the technology of the present disclosure, the defocus amount DF calculated in the pixel addition mode is divided into a suitable defocus amount ADF and a non-suitable defocus amount by the employment condition 67, and the subject distance is detected by using the suitable defocus amount ADF. In this manner, it is possible to suppress a decrease in detection accuracy of the subject distance, compared to a case where the subject distance is detected by using all of the defocus amounts DF calculated in the pixel addition mode without any restriction.

The distance detection unit 73 detects the subject distance based on the suitable defocus amount ADFA. The focus lens driving controller 74 performs focusing control according to the subject distance. Therefore, it is possible to perform the focusing control according to the subject distance at which the detection accuracy is relatively high.

As shown in FIG. 18, the employment condition 67 is the content that the defocus amount DF related to the difference between the current position of the focus lens 14 and the focusing position of the focus lens 14 is equal to or less than the second threshold value amount THA2. Therefore, it is possible to easily determine whether or not the defocus amount DF is the suitable defocus amount ADF.

In the present example, a defocus amount DF, which is a value related to a difference between the current position and the focusing position of the focus lens 14, is used as the focusing evaluation value. The defocus amount DF is a very general value, and a method of calculating the defocus amount DF is also established. Therefore, the defocus amount DF is appropriate as the focusing evaluation value. It should be noted that the phase difference α may be used as the focusing evaluation value instead of the defocus amount DF.

As illustrated in FIG. 17, the mode switching unit 90 switches between a pixel addition mode in which the calculation signal 43P is added and a non-pixel addition mode in which the calculation signal 43P is not added. Therefore, in a case where the subject distance fluctuates greatly as shown in FIG. 14 in the non-pixel addition mode and a situation where the defocus amount DF cannot be calculated occurs, the situation can be avoided by switching to the pixel addition mode.

In a case where the suitable defocus amount ADF is not present, the focus lens driving controller 74 does not perform the focusing control using the suitable defocus amount ADF. Therefore, it is possible to suppress the deterioration in the quality of the focusing control, compared to a case where the subject distance is forcibly detected using the defocus amount DF of the set value instead of the calculated defocus amount DF and the focusing control corresponding to the detected subject distance is performed.

As illustrated in FIGS. 12A and 12B, the pixel addition unit 91 adds the calculation signal 43P of the phase-difference detection pixel 41P that is continuous in the X direction which is the phase-difference detection direction. Therefore, the calculation data after addition DCA can be handled in the same manner as the calculation data DC, and the detection of the phase difference α and the calculation of the defocus amount DF based on the calculation data after addition DCA can also be performed without any problem.

### Second Embodiment

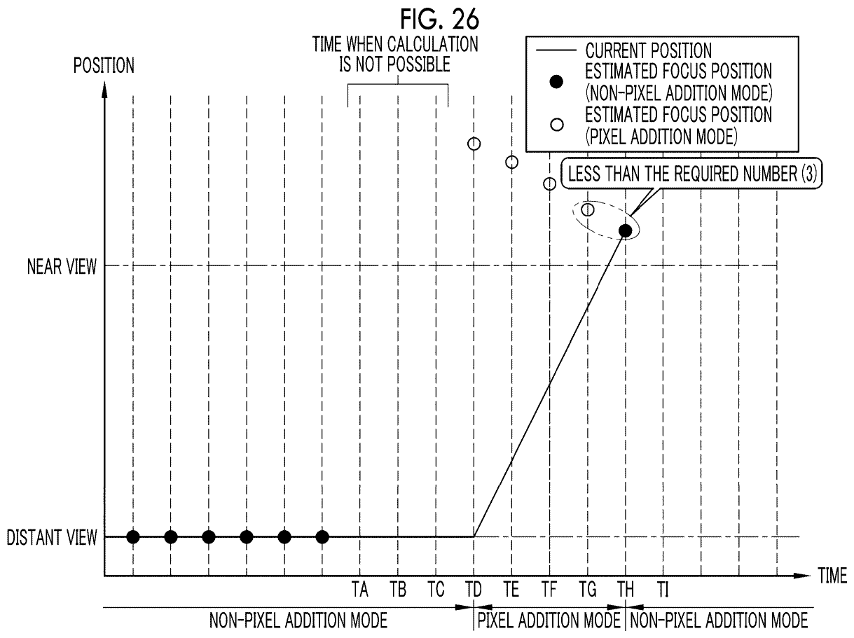

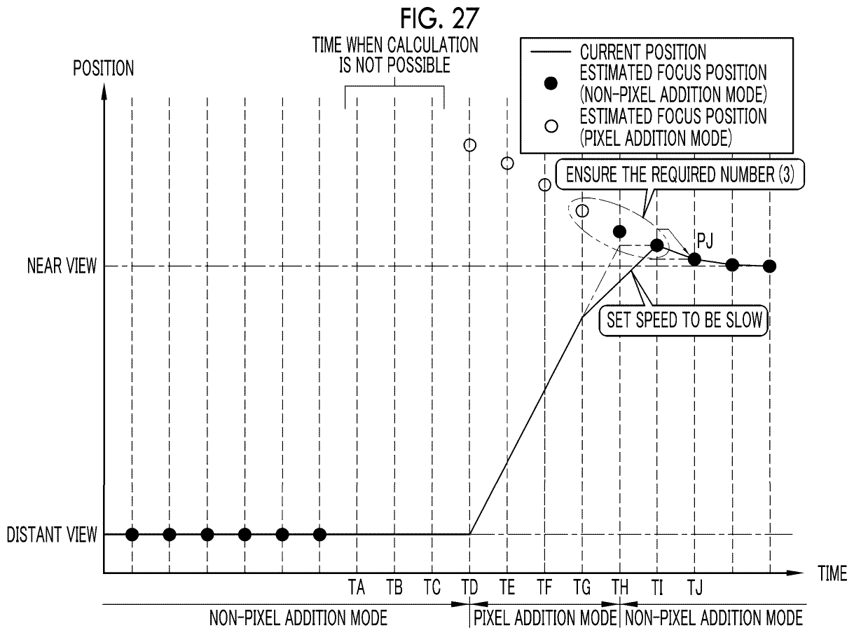

As shown in FIG. 26 as an example, in a case where the speed of the focus lens 14 is relatively fast or the subject is moving, there is a concern that a situation in which the number of the suitable defocus amounts ADF is less than the required number (three in FIG. 26) may occur. Therefore, in such a case, as shown in FIG. 27 as an example, the focus lens driving controller 74 sets the speed of the focus lens 14 to a speed at which the required number of the suitable defocus amounts ADF can be ensured at a timing (in FIG. 27, a time TG) at which the defocus amount DF satisfies the second switching condition 662 and it is decided to switch from the pixel addition mode to the non-pixel addition mode. Specifically, the focus lens driving controller 74 sets the speed of the focus lens 14 to be slow. The speed at which the required number of suitable defocus amounts ADF can be ensured is a speed related to a vector sum of a vector of a movement locus that the focus lens 14 is supposed to follow at the original speed and a vector parallel to a time axis of one output (one frame) of the focusing calculation result 81. The more the required number of vectors parallel to the time axis is, the longer the vectors are, and the slower the speed of the focus lens 14 is set.

By setting the speed of the focus lens 14 to be slow, the defocus amount DF can be acquired at the time TI in addition to the suitable defocus amount ADF at the time TG and the defocus amount ADF at the time TH. Accordingly, the subject distance can be detected using the three suitable defocus amounts ADF at the times TG, TH, and TI at the time TI. As a result, at the time TJ, the defocus amount DF corresponding to the subject distance detected at the time TI is calculated, and the estimated focus position PJ is detected.

As described above, in the second embodiment, the focus lens driving controller 74 sets the speed of the focus lens 14 to the speed at which the required number of the suitable defocus amounts ADF can be ensured. Therefore, it is possible to ensure the required number of the suitable defocus amounts ADF regardless of the speed of the focus lens 14, and it is possible to move the focus lens 14 to a position corresponding to the subject distance. In addition, in a case where the speed of the focus lens 14 is set to the fastest speed in normal cases and the speed of the focus lens 14 is set to a slow speed only in a case where the required number of suitable defocus amounts ADF cannot be ensured, the speed of the normal automatic focusing control can be prevented from being slow.

### Third Embodiment

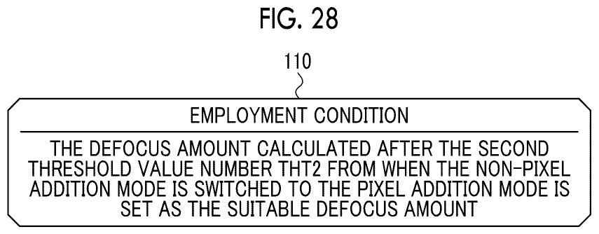

As shown in FIG. 28 as an example, the employment condition 110 of the third embodiment stipulates that the defocus amount DF calculated after a second threshold value number THT2 from when the non-pixel addition mode is switched to the pixel addition mode is set as the suitable defocus amount ADF. The second threshold value number THT2 is, for example, three. The employment condition 110 is an example of a “condition” according to the technology of the present disclosure. The second threshold value number THT2 is an example of a “first threshold value number”according to the technology of the present disclosure.

Since the employment condition 110 is as described above, in the third embodiment, the employability determination unit 72 determines that the defocus amount DF calculated until the setting time elapses after switching from the non-pixel addition mode to the pixel addition mode is not the suitable defocus amount ADF. Therefore, in this case, the distance detection unit 73 does not perform the detection of the subject distance. The setting time is a time from the switching to the pixel addition mode to the calculation of the defocus amount DF of the second threshold value number THT2.

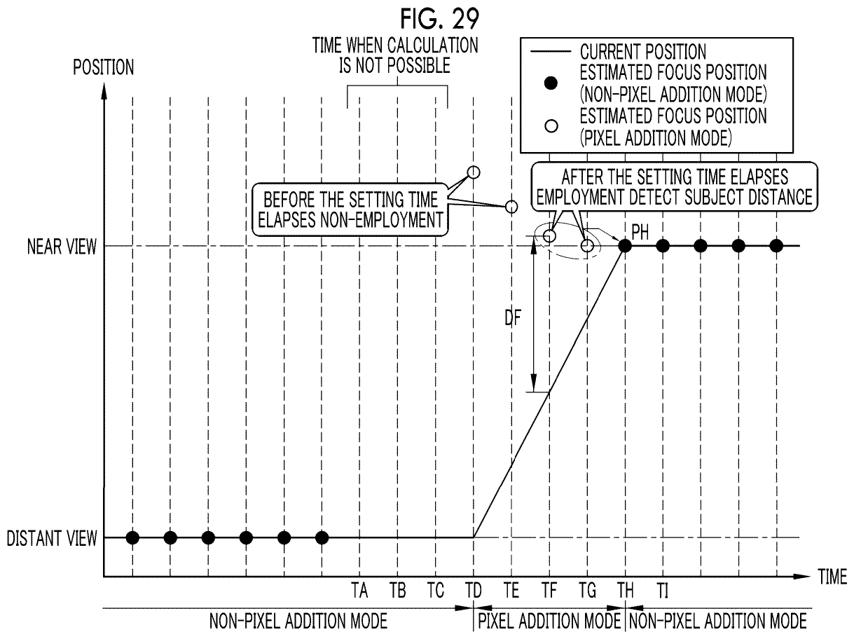

As an example, as illustrated in FIG. 29, a time TD for switching from the non-pixel addition mode to the pixel addition mode and a subsequent time TE are before the setting time elapses. Therefore, the employability determination unit 72 does not employ the defocus amount DF at the time TD and TE as the suitable defocus amount ADF. Therefore, the distance detection unit 73 does not perform the detection of the subject distance in the time TD and TE.

The time TF and the next time TG are after the second threshold value number THT2 from when the non-pixel addition mode is switched to the pixel addition mode. Therefore, the employability determination unit 72 employs the defocus amount DF at the time TF and TG as the suitable defocus amount ADF. The distance detection unit 73 detects the subject distance using the suitable defocus amount ADF in the time TF and TG. Accordingly, at the time TH, the defocus amount DF corresponding to the subject distance detected at the time TG is calculated, and the estimated focusing position PH is detected.

As described above, in the third embodiment, the employment condition 110 stipulates that the defocus amount DF calculated after the second threshold value number THT2 from when the non-pixel addition mode is switched to the pixel addition mode is set as the suitable defocus amount ADF. Therefore, the subject distance can be detected using the defocus amount DF having relatively high calculation accuracy. In addition, in the third embodiment, the employability determination unit 72 determines that the defocus amount DF calculated until the switching from the non-pixel addition mode to the pixel addition mode and the elapse of the setting time is not the suitable defocus amount ADF. Therefore, it is possible to prevent the subject distance from being detected using the defocus amount DF having relatively low calculation accuracy and to prevent the erroneous subject distance from being predicted. Even in the third embodiment, it is possible to suppress a decrease in detection accuracy of the subject distance, compared to a case where the subject distance is detected by using all the defocus amounts DF calculated in the pixel addition mode without any restriction.

### Fourth Embodiment

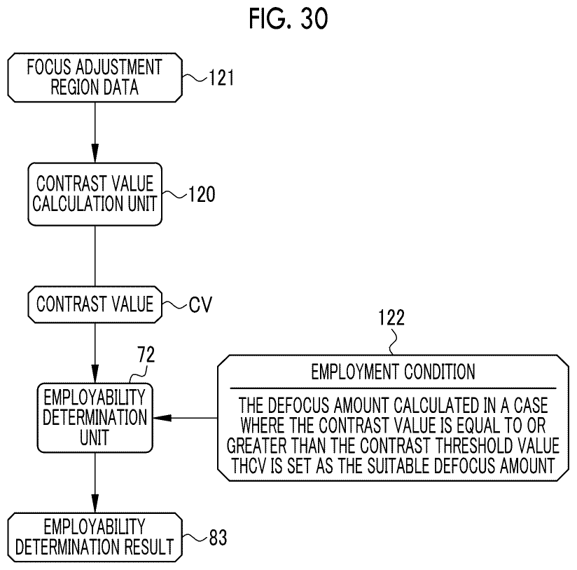

As shown in FIG. 30 as an example, in the fourth embodiment, a contrast value calculation unit 120 is provided in front of the employability determination unit 72. Focus adjustment region data 121 is input to the contrast value calculation unit 120. The focus adjustment region data 121 is a set of the image generation signals 43N output from the normal pixels 41N present in the focus adjustment region 50. The contrast value calculation unit 120 obtains a contrast value CV of the focus adjustment region data 121 and outputs the obtained contrast value CV to the employability determination unit 72. Since there are a plurality of focus adjustment regions 50, the contrast value calculation unit 120 obtains the contrast value CV for each of the plurality of focus adjustment regions 50 and outputs the average value thereof to the employability determination unit 72. The contrast value CV is a so-called brightness contrast, and here, is a ratio of a relative brightness of the brightest color to a relative brightness of the darkest color of the focus adjustment region data 121.

The employment condition 122 in the fourth embodiment is such that the defocus amount DF calculated in a case where the contrast value CV is equal to or greater than the contrast threshold value THCV is set as the suitable defocus amount ADF. The employment condition 122 is an example of a “condition” according to the technology of the present disclosure. The contrast threshold value THCV is an example of a “second threshold value range” according to the technology of the present disclosure. In addition, the contrast threshold value THCV or more is an example of “within the second threshold value range” according to the technology of the present disclosure.

The employability determination unit 72 determines to employ the defocus amount DF calculated in a case where the contrast value CV is equal to or greater than the contrast threshold value THCV, as the suitable defocus amount ADF. On the other hand, the employability determination unit 72 determines not to employ the defocus amount DF calculated in a case where the contrast value CV is less than the contrast threshold value THCV, as the suitable defocus amount ADF.

As described above, in the fourth embodiment, the contrast value calculation unit 120 obtains the contrast value CV in the focus adjustment region 50. The employment condition 122 is such that the defocus amount DF calculated in a case where the contrast value CV is equal to or greater than the contrast threshold value THCV is set as the suitable defocus amount ADF. In general, as the focus lens 14 approaches the focusing position, the contrast value CV increases, and the calculation accuracy of the defocus amount DF also increases. Therefore, in a case where a restriction that the contrast value CV is equal to or greater than the contrast threshold value THCV is provided, the subject distance can be detected by using the defocus amount DF having relatively high calculation accuracy. Therefore, even in the fourth embodiment, it is possible to suppress the decrease in the detection accuracy of the subject distance as compared with a case where the subject distance is detected by using all the defocus amounts DF calculated in the pixel addition mode without any restriction.

The set region is not limited to the illustrated focus adjustment region 50. The set region may be the entire imaging surface 42. In addition, in a case where the imaging apparatus 10 has a function of the automatic focusing control by the contrast method, the contrast value CV derived in the automatic focusing control by the contrast method may be used.

### Fifth Embodiment

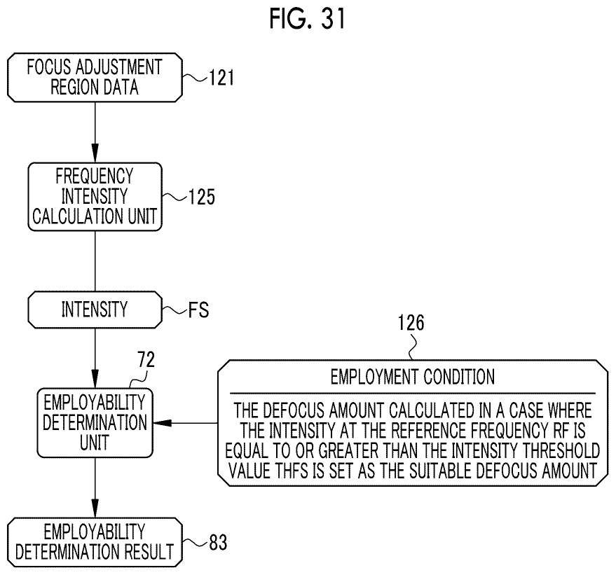

As shown in FIG. 31 as an example, in the fifth embodiment, a frequency intensity calculation unit 125 is provided in front of the employability determination unit 72. The focus adjustment region data 121 is input to the frequency intensity calculation unit 125. The frequency intensity calculation unit 125 performs known frequency analysis such as Fourier transform on the focus adjustment region data 121 to obtain an intensity FS of each frequency component in a predetermined frequency band of the focus adjustment region data 121, and outputs the obtained intensity FS to the employability determination unit 72. The frequency band set in advance is, for example, 1 Hz to 1000 Hz. Since there are a plurality of focus adjustment regions 50, the frequency intensity calculation unit 125 obtains the intensity FS for each of the plurality of focus adjustment regions 50 and outputs the average value thereof to the employability determination unit 72.

The employment condition 126 in the fifth embodiment is such that the defocus amount DF calculated in a case where the intensity FS at the reference frequency RF is equal to or greater than the intensity threshold value THFS is set as the suitable defocus amount ADF. The reference frequency RF is, for example, a cut-off frequency on a high frequency side of a band-pass filter used for filter processing on the first calculation data DC1 and the second calculation data DC2. The employment condition 126 is an example of a “condition” according to the technology of the present disclosure. The intensity threshold value THFS is an example of a “third threshold value range” according to the technology of the present disclosure. In addition, the intensity threshold value THFS or more is an example of “within the third threshold value range”according to the technology of the present disclosure.

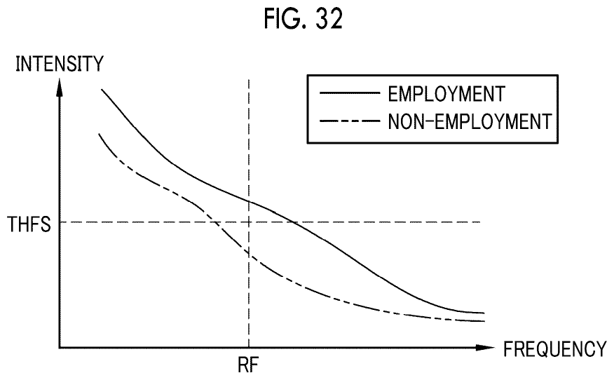

As an example, as shown by a solid line in FIG. 32, the employability determination unit 72 determines to employ the defocus amount DF calculated in a case where the intensity FS at the reference frequency RF is equal to or greater than the intensity threshold value THFS, as the suitable defocus amount ADF. As shown by a two-dot chain line, the employability determination unit 72 determines not to employ the defocus amount DF calculated in a case where the intensity FS at the reference frequency RF is less than the intensity threshold value THFS, as the suitable defocus amount ADF.

As described above, in the fifth embodiment, the frequency intensity calculation unit 125 obtains the intensity FS of the frequency component in the focus adjustment region 50. The employment condition 126 is such that the defocus amount DF calculated in a case where the intensity FS at the reference frequency RF is equal to or greater than the intensity threshold value THFS is set as the suitable defocus amount ADF. In general, as the focus lens 14 approaches the focusing position, the intensity FS of the high frequency increases, and the calculation accuracy of the defocus amount DF also increases. Therefore, in a case where a restriction that the intensity FS at the reference frequency RF is equal to or greater than the intensity threshold value THFS is provided, the subject distance can be detected by using the defocus amount DF having relatively high calculation accuracy. Therefore, even in the fifth embodiment, it is possible to suppress the decrease in the detection accuracy of the subject distance, as compared with a case where the subject distance is detected by using all the defocus amounts DF calculated in the pixel addition mode without any restriction.

As in the case of the fourth embodiment, the set region is not limited to the focus adjustment region 50 in the example. The set region may be the entire imaging surface 42. In addition, the focus adjustment region data 121 may be a set of the calculation signals 43P output from the phase-difference detection pixels 41P present in the focus adjustment region 50.

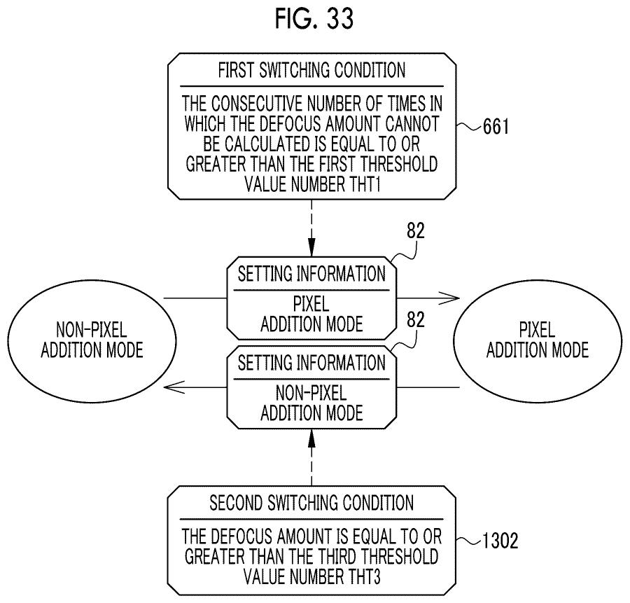

In the first embodiment, the second switching condition 662 of which the content is that the defocus amount DF is equal to or less than the first threshold value amount THA1 is exemplified, but the present invention is not limited to this. As an example, as shown in FIG. 33, the content may be that the consecutive number of times, in which the defocus amount DF is calculated, is equal to or greater than a third threshold value number THT3, as in the second switching condition 1302. The third threshold value number THT3 is, for example, four times.

The number of pieces of the calculation signal 43P to be added in the pixel addition processing is not limited to four pieces of the calculation signal 43P as illustrated. The number of pieces of the calculation signal 43P to be added in the pixel addition processing may be six or eight. In a case where the defocus amount DF cannot be calculated even after the pixel addition processing for four pixels is performed, a configuration may be adopted in which the pixel addition processing for six pixels or eight pixels is switched to.

In each of the above-described embodiments, a case has been described in which the scene is switched from the distant view to the near view, but the present invention is not limited to this. On the contrary, the technology of the present disclosure can also be applied to a case where the scene is switched from the near view to the distant view. In addition, in each of the above-described embodiments, a case of the video capturing has been described as an example, but the present disclosure is not limited to this. The technology of the present disclosure may be applied in a case of capturing a static image or displaying a live view image.

The imaging apparatus according to the technology of the present disclosure is not limited to the above-described mirrorless single-lens digital camera, and may be a compact digital camera, a video camera, a surveillance camera, a smartphone, or a tablet terminal.

In each of the above-described embodiments, for example, as a hardware structure of a processing unit that executes various types of processing, such as the image processing unit 27, the display controller 30, the instruction receiving unit 32, the focusing controller 68, the focusing calculation unit 70, the mode switching setting unit 71, the employability determination unit 72, the distance detection unit 73, the focus lens driving controller 74, the mode switching unit 90, the pixel addition unit 91, the correlation calculation unit 92, the defocus amount calculation unit 93, the contrast value calculation unit 120, and the frequency intensity calculation unit 125, various processors shown below can be used. The various processors include, for example, the CPU 56 which is a general-purpose processor that executes software (operation program 65) to function as various processing units, a programmable logic device (PLD), such as a field programmable gate array (FPGA), which is a processor of which a circuit configuration can be changed after manufacture, and/or a dedicated electric circuit, such as an application specific integrated circuit (ASIC), which is a processor of which a dedicated circuit configuration is designed to execute specific processing.

One processing unit may be configured by one of these various processors, or may be configured by a combination of two or more processors of the same type or different types (for example, a combination of a plurality of FPGAs and/or a combination of a CPU and an FPGA). In addition, a plurality of processing units may be configured with one processor.

As an example in which the plurality of processing units are configured by one processor, first, as represented by a computer, such as a client and a server, there is a form in which one processor is configured by a combination of one or more CPUs and software, and the processor functions as the plurality of processing units. Second, as represented by a system on a chip (SoC) or the like, there is a form in which a processor, which implements the functions of the entire system including the plurality of processing units with a single integrated circuit (IC) chip, is used. In this way, as the hardware structure, the various processing units are configured by using one or more of the various processors described above.

Further, more specifically, an electric circuit (circuitry), in which circuit elements such as semiconductor elements are combined, can be used as the hardware structure of the various processors.

The technology according to the following appendices can be perceived from the above description.

### [Supplementary Note 1]

A focusing control device comprising:
a processor,
wherein the processor is configured to
acquire a focusing evaluation value corresponding to an added value of pixel values of a plurality of phase-difference detection pixels, and
perform focusing control using the focusing evaluation value satisfying a predetermined condition.

### [Supplementary Note 2]

The focusing control device according to Supplementary note 1,
wherein the processor is configured to
detect a distance to a subject based on the focusing evaluation value satisfying the condition, and
perform the focusing control corresponding to the distance.

### [Supplementary Note 3]

The focusing control device according to Supplementary Note 1 or 2,
wherein the condition is that the focusing evaluation value related to a difference between a current position of a focus lens and a focusing position of the focus lens is within a first threshold value range.

### [Supplementary Note 4]

The focusing control device according to Supplementary note 3,
wherein the processor is configured to set a speed of the focus lens to a speed at which a predetermined number of the focusing evaluation values is ensured.

### [Supplementary Note 5]

The focusing control device according to any one of Supplementary Notes 1 to 4,
wherein the processor is configured to switch between a pixel addition mode in which the pixel value is added and a non-pixel addition mode in which the pixel value is not added.

### [Supplementary Note 6]

The focusing control device according to Supplementary Note 5,
wherein the focusing evaluation value satisfying the condition is the focusing evaluation value acquired after a first threshold value number from when the non-pixel addition mode is switched to the pixel addition mode.

### [Supplementary Note 7]

The focusing control device according to Supplementary Note 5 or 6,
wherein the processor is configured not to set the focusing evaluation value, which is acquired until a setting time elapses after switching from the non-pixel addition mode to the pixel addition mode, as the focusing evaluation value satisfying the condition.

### [Supplementary Note 8]

The focusing control device according to any one of Supplementary Notes 1, 2, or 5,
wherein the processor is configured to obtain a contrast value in a set region on an imaging surface of an imaging element in which the phase-difference detection pixels are arranged, and
the focusing evaluation value satisfying the condition is the focusing evaluation value calculated in a case where the contrast value is within a second threshold value range.

### [Supplementary Note 9]

The focusing control device according to any one of Supplementary notes 1, 2, or 5,
wherein the processor is configured to obtain an intensity of a frequency component in a set region on an imaging surface of an imaging element in which the phase-difference detection pixels are arranged, and
the focusing evaluation value satisfying the condition is the focusing evaluation value calculated in a case where the intensity at a reference frequency is within a third threshold value range.

### [Supplementary Note 10]

The focusing control device according to any one of Supplementary notes 1 to 9, wherein the processor is configured not to perform the focusing control using the focusing evaluation value in a case where the focusing evaluation value satisfying the condition is not present.

### [Supplementary Note 11]

The focusing control device according to any one of Supplementary Notes 1 to 10,
wherein the processor is configured to add the pixel values of the plurality of phase-difference detection pixels that are connected in a phase-difference detection direction.

### [Supplementary Note 12]

The focusing control device according to any one of Supplementary notes 1 to 11,
wherein the processor is configured to
switch between a pixel addition mode in which the pixel value is added and a non-pixel addition mode in which the pixel value is not added,
switch to the pixel addition mode in a case where a first switching condition set in advance is satisfied in the non-pixel addition mode, and
switch to the non-pixel addition mode in a case where a second switching condition set in advance is satisfied in the pixel addition mode.

### [Supplementary Note 13]

The focusing control device according to Supplementary Note 12,
wherein the first switching condition is a content that the consecutive number of times, in which the focusing evaluation value is not calculable in the non-pixel addition mode, is equal to or greater than the second threshold value number.

### [Supplementary Note 14]

The focusing control device according to Supplementary Note 12 or 13,
wherein the second switching condition is that the focusing evaluation value is within a fourth threshold value range.

### [Supplementary Note 15]

The focusing control device according to Supplementary Note 12 or 13,
wherein the second switching condition is a content that the consecutive number of times, in which the focusing evaluation value is calculated in the pixel addition mode, is equal to or greater than the third threshold value number.

### [Supplementary Note 16]

An imaging apparatus comprising the focusing control device according to any one of Supplementary Notes 1 to 15.

The first threshold value number THT1 is an example of a “second threshold value number” in Supplementary note 13. The first threshold value amount THA1 is an example of a “fourth threshold value range” in Supplementary note 14. The first threshold value amount THA1 or less is an example of “within the fourth threshold value range” in Supplementary note 14. The third threshold value number THT3 is an example of a “third threshold value number of times” in Supplementary Note 15.

The technology of the present disclosure can also be combined with various embodiments and/or various modification examples described above, as appropriate. In addition, it goes without saying that the present disclosure is not limited to each of the embodiments described above, various configurations can be adopted as long as the configuration does not deviate from the gist. Furthermore, the technology of the present disclosure extends to a storage medium that non-transitorily stores the program, and a computer program product including the program, in addition to the program.

The above-described contents and the above-shown contents are the detailed description of the parts according to the technology of the present disclosure, and are merely an example of the technology of the present disclosure. For example, the above description of the configuration, the function, the operation, and the effect are the description of examples of the configuration, the function, the operation, and the effect of the parts according to the technology of the present disclosure. Accordingly, it goes without saying that unnecessary parts may be deleted, new elements may be added, or replacements may be made with respect to the above-described contents and the above-shown contents within a range that does not deviate from the gist of the technology of the present disclosure. In addition, in order to avoid complications and facilitate grasping the parts according to the technology of the present disclosure, in the above-described contents and the above-shown contents, the description of technical general knowledge and the like that do not particularly require description for enabling the implementation of the technology of the present disclosure are omitted.

In the present specification, “A and/or B” has the same meaning as “at least one of A or B”. That is, “A and/or B” means that it may be only A, only B, or a combination of A and B. In addition, in the present specification, also in a case where three or more matters are expressed in association by “and/or”, the same concept as “A and/or B”is applied.

All of the documents, the patent applications, and the technical standards described in the present specification are incorporated herein by reference to the same extent as in a case where each of the documents, patent applications, and technical standards is specifically and individually described by being incorporated by reference.

What is claimed is:

1. A focusing control device comprising:
a processor,
wherein the processor is configured to
acquire a focusing evaluation value corresponding to an added value of pixel values of a plurality of phase-difference detection pixels, and
perform focusing control using the focusing evaluation value satisfying a predetermined condition.

2. The focusing control device according to claim 1,
wherein the processor is configured to
detect a distance to a subject based on the focusing evaluation value satisfying the condition, and
perform the focusing control corresponding to the distance.

3. The focusing control device according to claim 1,
wherein the condition is that the focusing evaluation value related to a difference between a current position of a focus lens and a focusing position of the focus lens is within a first threshold value range.

4. The focusing control device according to claim 3,
wherein the processor is configured to set a speed of the focus lens to a speed at which a predetermined number of the focusing evaluation values is ensured.

5. The focusing control device according to claim 1,
wherein the processor is configured to switch between a pixel addition mode in which the pixel value is added and a non-pixel addition mode in which the pixel value is not added.

6. The focusing control device according to claim 5,
wherein the focusing evaluation value satisfying the condition is the focusing evaluation value acquired after a first threshold value number from when the non-pixel addition mode is switched to the pixel addition mode.

7. The focusing control device according to claim 5,
wherein the processor is configured not to set the focusing evaluation value, which is acquired until a setting time elapses after switching from the non-pixel addition mode to the pixel addition mode, as the focusing evaluation value satisfying the condition.

8. The focusing control device according to claim 1,
wherein the processor is configured to obtain a contrast value in a set region on an imaging surface of an imaging element in which the phase-difference detection pixels are arranged, and
the focusing evaluation value satisfying the condition is the focusing evaluation value calculated in a case where the contrast value is within a second threshold value range.

9. The focusing control device according to claim 1,
wherein the processor is configured to obtain an intensity of a frequency component in a set region on an imaging surface of an imaging element in which the phase-difference detection pixels are arranged, and
the focusing evaluation value satisfying the condition is the focusing evaluation value calculated in a case where the intensity at a reference frequency is within a third threshold value range.

10. The focusing control device according to claim 1,
wherein the processor is configured not to perform the focusing control using the focusing evaluation value in a case where the focusing evaluation value satisfying the condition is not present.

11. The focusing control device according to claim 1,
wherein the processor is configured to add the pixel values of the plurality of phase-difference detection pixels that are connected in a phase-difference detection direction.

12. An operation method of a focusing control device, the method comprising:
acquiring a focusing evaluation value corresponding to an added value of pixel values of a plurality of phase-difference detection pixels; and
performing focusing control using the focusing evaluation value satisfying a predetermined condition.

13. A non-transitory computer-readable storage medium storing an operation program of a focusing control device causing a computer to execute a process comprising:
acquiring a focusing evaluation value corresponding to an added value of pixel values of a plurality of phase-difference detection pixels; and
performing focusing control using the focusing evaluation value satisfying a predetermined condition.

14. An imaging apparatus comprising the focusing control device according to claim 1.
